(19) United States
(12) Patent Application Publication
(10) Pub. No.: US 2023/0048095 A1
(43) Pub. Date: Feb. 16, 2023

(54) HIGH SAFETY AND HIGH CAPACITY LITHIUM METAL BATTERIES IN IONIC LIQUID ELECTROLYTE WITH A SODIUM ADDITIVE

(71) Applicant: The Board of Trustees of the Leland Stanford Junior University, Stanford, CA (US)

(72) Inventors: Hongjie Dai, Stanford, CA (US); Hao Sun, Stanford, CA (US)

(73) Assignee: The Board of Trustees of the Leland Stanford Junior University, Stanford, CA (US)

(21) Appl. No.: 17/790,032

(22) PCT Filed: Dec. 29, 2020
(86) PCT No.: PCT/US2020/067378

§ 371 Date: Jun. 29, 2022

Related U.S. Application Data
(60) Provisional application No. 62/955,201, filed on Dec. 30, 2019.

(51) Int. Cl. H01M 10/0568; H01M 10/0567; H01M 10/052

(52) U.S. Cl. CPC H01M 10/0568; H01M 10/0567; H01M 10/052; H01M 2300/0025

(57) ABSTRACT

Disclosed herein are ionic liquid electrolytes comprising lithium cations, sodium cations, organic cations, and fluorinated anions, wherein a concentration of the lithium cations is about 1.3 M or greater. Also disclosed are batteries comprising an anode, a cathode, and the electrolyte of this disclosure disposed between the anode and the cathode.

### CROSS-REFERENCE TO RELATED APPLICATIONS

This application claims the benefit of and priority to U.S. Patent Application No. 62/955,201, filed on Dec. 30, 2019, the contents of which are incorporated herein in their entirety.

### BACKGROUND

Rechargeable lithium metal batteries are next generation energy storage devices with high energy density for various applications from portable electronics, grid energy storage, and electric vehicles. It has been challenging to produce high voltage and energy density batteries using reactive lithium metal anodes while achieving high safety and long cycle life.

Rechargeable lithium battery systems with high energy density have been intensely explored in the past decade, driven by wide ranging demands from consumer electronics to electric automotive industry. As the most promising negative electrode, Li metal provides a high theoretical specific capacity (3,860 mAh g⁻¹) and negative reduction potential (−3.04 V versus standard hydrogen electrode) useful for high voltage and high energy density Li batteries. Ideally high-energy Li metal batteries should also be of high safety, a challenge to flammable organic solvent based electrolytes. While many strategies have been explored including functional separators and fire-retardancy electrolyte additives, developing intrinsically non-flammable electrolytes could fully address safety concerns.

It is against this background that a need arose to develop the embodiments described herein.

### BRIEF DESCRIPTION OF THE DRAWINGS

FIG. 1 shows an embodiment of properties of the non-flammable IL electrolyte. FIG. 1a shows a schematic illustration of the battery configuration and electrolyte composition of the HC—LiNa IL electrolyte. FIG. 1b shows Raman spectra of pure [EMIm]FSI, LC—Li and HC—LiNa IL. FIG. 1c shows ionic conductivity of the HC—LiNa IL at various temperatures. FIG. 1d shows thermal stability of the HC—LiNa IL electrolyte and comparative organic electrolyte composed of 1 M LiPF₆ in EC/DMC (about 1:1 by vol.). FIG. 1e, f, show flammability test of the HC—LiNa IL electrolyte (FIG. 1e) and comparative organic electrolyte composed of 1 M LiPF₆ in EC/DMC (about 1:1 by vol.) (FIG. 1f). Scale bars in FIG. 1e, f, are 1 cm.

FIG. 2 shows an embodiment of electrochemical properties of the different IL electrolytes. FIG. 2a shows CV curves of a Li—Cu cell using HC—LiNa IL electrolyte at a scan rate of about 2 mV s⁻¹. FIG. 2b shows Li plating/stripping profiles of a Li—Cu cell using HC—LiNa IL electrolyte. FIG. 2c shows Coulombic efficiency of Li plating/stripping in a Li—Cu cell using LC—Li and HC—LiNa IL electrolytes. Current density and areal specific capacity in FIG. 2b, c: about 0.5 mA cm⁻² and about 0.5 mAh cm⁻², respectively. FIG. 2d shows Li plating/stripping profiles of a symmetrical Li/Li cell using HC—LiNa IL electrolyte at different cycles. FIG. 2e shows Li plating/stripping profiles of symmetrical Li/Li cells using LC—Li, HC—Li and HC—LiNa IL electrolytes. Current density and areal specific capacity in FIG. 2d, e: about 1 mA cm⁻² and about 1 mAh cm⁻², respectively.

FIG. 3 shows an embodiment of electrochemical performances of Li metal-LiCoO₂ batteries using HC—LiNa IL electrolyte. FIG. 3a shows a schematic illustration of the configuration of Li metal-LiCoO₂ battery. FIG. 3b shows CV curves of a Li metal-LiCoO₂ battery using HC—LiNa IL electrolyte at a scan rate of about 0.2 mV s⁻¹. FIG. 3c, Galvanostatic charge-discharge curves of a Li metal-LiCoO₂ battery using HC—LiNa IL electrolyte at varied rates from about 0.25 to about 3 C. FIG. 3d shows rate capability of a Li metal-LiCoO₂ battery using HC—LiNa IL electrolyte. LiCoO₂ mass loading in FIG. 3b-d: about 6 mg cm⁻²). FIG. 3e, Cyclic stability of Li metal-LiCoO₂ batteries (LiCoO₂ mass loading: about 6 mg cm⁻²) using LC—Li, HC—Li and HC—LiNa IL electrolytes at about 1 C. FIG. 3f shows cyclic stability of a Li metal-LiCoO₂ battery (LiCoO₂ mass loading: about 12 mg cm⁻²) using HC—LiNa IL electrolyte at about 0.35 C. FIG. 3g shows cyclic stability of Li metal-LiCoO₂ batteries (LiCoO₂ mass loading: about 12 mg cm⁻²) using about 1 M LiPF₆ in EC/DMC (about 1:1 by vol.) with about 2 wt. % FEC organic electrolyte and HC—LiNa IL electrolyte. The batteries were first charge/discharge at about 0.25 C for 2 cycles, and then cycled at about 0.7 C (about 1.2 mA cm⁻²) for cyclic stability comparison.

FIG. 4 shows an embodiment of Li@Cu—LiCoO₂ batteries in HC—LiNa IL electrolyte. FIG. 4a shows a schematic illustration of the configuration of the Li@Cu—LiCoO₂ battery. Controlled amount of Li was plated on a Cu foil serving as the negative electrode. FIG. 4b shows an SEM image of the plated Li on Cu foil with an areal capacity of about 2 mAh cm⁻². Scale bar, 5 FIG. 4c. The initial three galvanostatic charge-discharge curves of a Li@Cu—LiCoO₂ battery at about 0.25 C. FIG. 4d, e show galvanostatic charge-discharge curves of a Li@Cu—LiCoO₂ battery using gHC—LiNa IL at about 0.7 C. FIG. 4e shows cyclic stability of Li@Cu—LiCoO₂ batteries using HC—LiNa IL and organic electrolyte at about 0.7 C. The capacity of the plated Li (negative electrode) in Figures c-e were all about 2 times in excess compared with that of LiCoO₂ (positive electrode, about 10 mg cm⁻²).

FIG. 5 shows an embodiment of NCM 811 based Li metal batteries in HC—LiNa IL electrolyte. FIG. 5a shows schematic illustration of the configuration of NCM 811 based Li metal batteries. Both Li metal and Li@Cu foils can be used as the negative electrodes. FIG. 5b shows galvanostatic charge-discharge curves of a Li metal-NCM 811 battery at various rates from about 0.25 to about 1 C (about 25 to about 200 mA g⁻¹). FIG. 5c shows cyclic stability of a Li metal-NCM 811 battery using HC—LiNa IL and organic electrolyte at about 0.5 C rate. The specific capacities in FIGS. 5b and c were calculated based on the mass of NCM 811 on positive electrode. FIG. 5d shows cyclic stability of a Li@Cu-NCM 811 battery with HC—LiNa IL at about 0.5 C rate. The capacity of the plated Li (negative electrode) in FIG. 5d was about 1.8 times in excess compared with the capacity of NCM 811 (positive electrode). The specific capacities in FIG. 5d was calculated based on the total mass of positive and negative electrodes. NCM 811 mass loading in FIGS. 5a-d: about 10 mg cm⁻².

FIG. 6 shows an embodiment of morphology and interfacial chemistry in HC—LiNa IL electrolytes. FIG. 6a, b show SEM images of Li negative electrodes in Li metal-LiCoO₂ batteries after 20 cycles at about 1.2 mA cm⁻² using HC—LiNa and HC—Li IL electrolytes, respectively. FIG. 6c, d show SEM images of Li negative electrodes in Li metal-LiCoO₂ batteries after 400 cycles at about 1.2 mA cm⁻² using HC—LiNa and HC—Li IL electrolytes, respectively. Scale bars in FIGS. 6a-d are 5 μm. FIG. 6e, f show a cross-section SEM images of Li negative electrodes in Li metal-LiCoO₂ batteries after 400 cycles at about 1.2 mA cm⁻² using HC—LiNa and HC—Li IL electrolytes, respectively. The batteries with LiCoO₂ mass loading of about 12 mg cm⁻² in FIGS. 6a-f were all stopped at fully charged state (corresponding to Li plating on Li negative electrode) in prior to characterization. Scale bars in FIG. 6e and f, 20 and 10 μm, respectively. FIG. 6g, h show a schematic illustration of the Li plating morphology in HC—LiNa and HC—Li IL electrolytes, respectively. FIG. 6 i-p show high-resolution XPS spectra at different sputtering depths for Li is (FIG. 6i), F 1s (FIG. 6j), S 2p (FIG. 6k), O 1s (FIG. 6l), C 1s (FIG. 6m) and Na 1s (FIG. 6n) of the Li negative electrode from a Li metal-LiCoO₂ battery. The battery was cycled at about 0.7 C rate (about 1.2 mA cm⁻²) for 20 cycles and stopped at fully charged state prior to characterization. FIG. 6o, p show element composition variation in solid-electrolyte interface (SEI) after different sputtering depths on Li negative electrodes of Li metal-LiCoO₂ batteries cycled in HC—LiNa (FIG. 6o) and HC—Li (FIG. 6p) IL electrolytes, respectively. FIG. 6q, High-angle annular dark-field (HAADF) and the corresponding element mapping images of NCM 811 cathode particles cycled in HC—LiNa IL electrolyte at about 0.5 C for 100 cycles. Scale bar in FIG. 6q is 200 nm.

FIG. 7 shows an embodiment of thermal stability test using HC—LiNa IL and comparative about 1 M LiPF₆ in EC/DMC (about 1:1 by vol.) organic electrolyte. EC: ethylene carbonate. DMC: dimethyl carbonate.

FIG. 8 shows an embodiment of Li plating/stripping profiles of a Li/Cu cell using HC—LiNa IL electrolyte at current densities of about 1 and about 2 mA cm⁻². A specific plating capacity of about 1 mAh cm⁻² was fixed for both cells.

FIG. 9 shows an embodiment of typical Li plating/stripping curves of Li/Cu cells using HC—LiNa and LC—Li IL electrolytes. Current density and plating capacity were set as about 0.5 mA cm⁻² and about 0.5 mAh cm⁻², respectively.

FIG. 10 shows an embodiment of the morphology of the Li plating on Cu foil in different IL electrolytes. Li plating was conducted in Li/Cu cells at about 0.5 mA cm⁻² and about 0.5 mAh cm⁻² using LC—Li (FIG. 10a, b), HC—Li (FIG. 10c, d) and HC—LiNa (FIG. 10e, f) IL electrolytes at different magnifications. The cell was pre-cycled for 15 cycles and stopped at fully discharging state before characterization. Scale bars in a, c and e: 10 μm. Scale bars in FIGS. 10b, d and f: 5 μm.

FIG. 11 shows an embodiment of the linear sweep voltammetry profile of a Li/Al cell using HC—LiNa IL electrolyte. Working electrode: Al foil. Counter and reference electrode: Li foil. Scan rate: about 1 mV s⁻¹.

FIG. 12 shows an embodiment of the initial five galvanostatic charge-discharge curves of a Li metal-LiCoO₂ battery using HC—LiNa IL electrolyte at about 0.25 C. LiCoO₂ mass loading: about 6 mg cm⁻².

FIG. 13 shows an embodiment of the Coulombic efficiency retention of Li metal-LiCoO₂ batteries using LC—Li, HC—Li and HC—LiNa IL electrolytes at about 1 C. LiCoO₂ mass loading: about 6 mg cm⁻².

FIG. 14 shows an embodiment of the Li metal-LiCoO₂ battery performances using IL electrolytes with different NaTFSI concentrations. FIG. 14a shows Galvanostatic charge-discharge curves of Li metal-LiCoO₂ batteries using IL electrolytes with about 0.16 M and about 0.48 M NaTFSI additives. FIG. 14b, c show capacity and CE retention of Li metal-LiCoO₂ batteries using IL electrolytes with about 0.16 M and about 0.48 M NaTFSI additives at about 1 C, respectively. LiCoO₂ mass loading: about 6 mg cm⁻².

FIG. 15 shows an embodiment of the initial three galvanostatic charge-discharge curves of a Li metal-LiCoO₂ battery using HC—LiNa IL electrolyte at about 0.25 C. LiCoO₂ mass loading: about 12 mg cm⁻².

FIG. 16 shows an embodiment of the cyclic stability of a Li metal-LiCoO₂ battery using HC—LiNa IL electrolyte with a high LiCoO₂ mass loading of about 16 mg cm⁻². Current density: about 0.8 mA cm⁻².

FIG. 17 shows an embodiment of an SEM image of the cross section of a Li@Cu foil. Scale bar: 20 μm.

FIG. 18 shows an embodiment of the Coulombic efficiency retention of Li@Cu—LiCoO₂ batteries using comparative organic and HC—LiNa IL electrolytes. The organic electrolyte was composed of about 1 M LiPF₆ in EC/DMC (about 1:1 by vol.) with about 2 wt. % FEC. LiCoO₂ mass loading: about 10 mg cm⁻².

FIG. 19 shows an embodiment of the cyclic stability of a Li@Cu—LiCoO₂ battery using HC—LiNa IL electrolyte at about 0.7 C (about 0.6 mA cm⁻²). LiCoO₂ mass loading: about 6 mg cm⁻². The capacity of the plated Li was about 2 times excess compared with the capacity of LiCoO₂.

FIG. 20 shows an embodiment of the typical galvanostatic charge-discharge curve of a Li metal-NCM 811 battery using HC—LiNa IL electrolyte at about 0.13 C. NCM 811 mass loading: about 10 mg cm⁻².

FIG. 21 shows an embodiment of the Galvanostatic charge-discharge curves at Cycles 2-4 of a Li@Cu-NCM 811 battery using HC—LiNa IL electrolyte at about 0.13 C. NCM 811 mass loading: about 10 mg cm⁻².

FIG. 22a, b, shows an embodiment of an SEM images of Li negative electrodes in Li metal-LiCoO₂ batteries after 20 cycles at about 1.2 mA cm⁻² using HC—Li IL electrolytes at low and high magnifications, respectively. The batteries with a LiCoO₂ mass loading of about 12 mg cm⁻² was stopped at fully charged state. Scale bars in FIG. 22a and b: 20 and 10 μm, respectively.

FIG. 23 shows an embodiment of the surface XPS profile of a Li negative electrode from a Li metal-LiCoO₂ battery at fully charged state. Prior to XPS measurement, the cell was cycled for 20 cycles at about 0.7 C (about 1.2 mA cm⁻²) for sufficient formation of SEI. LiCoO₂ mass loading: about 12 mg cm⁻².

FIG. 24 shows an embodiment of the high-resolution XPS spectra at different sputtering depths for Na Auger (FIG. 24a) and N 1s (FIG. 24b) of the Li negative electrode from a Li metal-LiCoO₂ battery. The battery was cycled at about 0.7 C rate (about 1.2 mA cm⁻²) for 20 cycles and stopped at fully charged state prior to characterization.

FIG. 25 shows an embodiment of a schematic illustration of the 4 e and 16 e reduction of FSI anion (FIGS. 25a and b), and 2 e and 20 e reduction of TFSI anion (FIGS. 25c and d), respectively.

FIG. 26 shows an embodiment of the cathode-electrolyte interphase (CEI) probing on NCM 811 cathode. TEM images of the NCM 811 cathodes without cycling (FIG. 26a, b), cycled in LC—Li (FIG. 26c, d) and HC—LiNa (FIG. 26e, f) IL electrolytes, respectively. Li metal-NCM 811 batteries with NCM 811 mass loading of about 10 mg cm⁻² were cycled at about 0.5 C for 100 cycles. Scale bars in FIG. 26a and c: 10 μm. Scale bar in e: 20 μm. Scale bars in FIG. 26b, d and f: 5 μm.

FIG. 27 shows an embodiment of the cathode-electrolyte interphase (CEI) probing on LiCoO₂ cathode. FIG. 27a, b show TEM images of the LiCoO₂ cathodes cycled in HC—LiNa IL electrolytes at low and high magnifications, respectively. The Li metal-LiCoO₂ battery with LiCoO₂ mass loading of about 12 mg cm⁻² was cycled at about 0.7 C for 100 cycles. Scale bars in FIG. 27a and b: 20 and 5 μm, respectively.

FIG. 28 shows an embodiment of the Galvanostatic charge-discharge curves of Li metal-LiCoO₂ batteries using about 2.5 M LiTFSI and about 0.16 M NaTFSI in [EMIm]TFSI IL electrolytes at about 0.25 C. LiCoO₂ mass loading: about 6 mg cm⁻².

FIG. 29 shows an embodiment of the role Na ion plays in cycling stability. Specific capacity (FIG. 29a) and CE (FIG. 29b) retention of Li metal-LiCoO₂ batteries based on about 5 M LiFSI in [EMIm]FSI ILs with NaTFSI, LiTFSI or no additives at about 1 C. LiCoO₂ mass loading: about 6 mg cm⁻².

FIG. 30 shows an embodiment of the role TFSI anion plays in cycling stability. Specific capacity (FIG. 30a) and CE (FIG. 30b) retention of Li metal-LiCoO₂ batteries based on about 5 M LiFSI in [EMIm]FSI ILs with NaTFSI, LiTFSI or no additives. LiCoO₂ mass loading: about 6 mg cm⁻².

FIG. 31a shows an embodiment of the Galvanostatic charge-discharge curves of Li metal-LiCoO₂ batteries using “5 M LiFSI+0.16 M NaTFSI in [EMIm]FSI” and “2 M LiFSI+2 M LiTFSI+0.16 M NaTFSI in [EMIm]FSI” at about 1 C. FIG. 31b shows an embodiment of the cyclic stability of a Li metal-LiCoO₂ battery using 2 M LiFSI+2 M LiTFSI+0.16 M NaTFSI in [EMIm]FSI IL electrolyte at about 1 C. LiCoO₂ mass loading: about 6 mg cm⁻².

FIG. 32 shows an embodiment of the Li metal-LiCoO₂ battery performances based on [EMIm]FSI and N-butyl-N-methylpyrrolidinium bis(fluorosulfonyl)imide ([Py13]FSI) IL electrolytes. FIG. 32a shows rate performance at about 0.25 to about 3 C. FIG. 32b shows cyclic stability at about 1 C. LiCoO₂ mass loading: about 6 mg cm⁻².

FIG. 33 shows an embodiment of the Li metal-NCM 811 battery performances based on IL electrolytes composed of about 4.2 M LiFSI in Py13FSI with and without about 0.16 M NaTFSI. FIG. 33a, FIG. 33b show retention of specific discharge capacity and CE at about 0.5 C (about 1 mA cm⁻²), respectively. NCM 811 mass loading: about 10 mg cm⁻².

### DETAILED DESCRIPTION

Some embodiments include an ionic liquid electrolyte comprising lithium cations, sodium cations, organic cations, and fluorinated anions, wherein a concentration of the lithium cations is about 1.3 M or greater. In some embodiments, the concentration of the lithium cations is about 1.5 M or greater, about 2 M or greater, about 2.5 M or greater, about 3 M or greater, about 3.5 M or greater, about 4 M or greater, about 4.5 M or greater, or about 5 M or greater. In some embodiments, a concentration of the sodium cations is about 0.05 M or greater, about 0.07 M or greater, about 0.1 M or greater, about 0.13 M or greater, or about 0.16 M or greater. In some embodiments, a ratio of the concentration of the lithium cations to the concentration of the sodium cations is about 12 or greater, about 15 or greater, about 17 or greater, about 20 or greater, about 23 or greater, about 25 or greater, about 27 or greater, or about 30 or greater. In some embodiments, the organic cations include imidazolium cations. In some embodiments, the imidazolium cations are 1,3-dialkylimidazolium cations. In some embodiments, the 1,3-dialkylimidazolium cations are 1-ethyl-3-methylimidazolium cations. In some embodiments, the fluorinated anions include first fluorinated anions and second fluorinated anions which are different from the first fluorinated anions. In some embodiments, the first fluorinated anions are first sulfonamide anions, and the second fluorinated anions are second sulfonamide anions which are different from the first sulfonamide anions. In some embodiments, the first sulfonamide anions are bis(fluorosulfonyl)imide anions, and the second sulfonamide anions bis(trifluoromethanesulfonyl)imide anions. In some embodiments, a concentration of the first sulfonamide anions is greater than a concentration of the second sulfonamide anions. In some embodiments, the ionic liquid electrolyte has a viscosity of up to about 200 mPa s at 22° C. In some embodiments, the viscosity is about 180 mPa s or less, about 160 mPa s or less, about 140 mPa s or less, or about 130 mPa s or less. In some embodiments, the ionic liquid electrolyte has an ionic conductivity of at least about 1.5 mS cm⁻¹ at 25° C. In some embodiments, the ionic conductivity is about 1.7 mS cm⁻¹ or greater, about 2 mS cm⁻¹ or greater, about 2.3 mS cm⁻¹ or greater, or about 2.6 mS cm⁻¹ or greater.

Additional embodiments include an ionic liquid electrolyte comprising an ionic liquid, a lithium salt, and a sodium salt, wherein a molar ratio of lithium included in the lithium salt to sodium included in the sodium salt is at least about 12. In some embodiments, the molar ratio of lithium included in the lithium salt to sodium included in the sodium salt is about 15 or greater, about 17 or greater, about 20 or greater, about 23 or greater, about 25 or greater, about 27 or greater, or about 30 or greater. In some embodiments, the ionic liquid includes organic cations and fluorinated anions. In some embodiments, the organic cations include imidazolium cations. In some embodiments, the imidazolium cations are 1,3-dialkylimidazolium cations. In some embodiments, the 1,3-dialkylimidazolium cations are 1-ethyl-3-methylimidazolium cations. In some embodiments, the fluorinated anions are sulfonamide anions. In some embodiments, the sulfonamide anions are bis(fluorosulfonyl)imide anions. In some embodiments, the lithium salt includes lithium cations and fluorinated anions. In some embodiments, the fluorinated anions included in the lithium salt are sulfonamide anions. In some embodiments, the sulfonamide anions included in the lithium salt are bis(fluorosulfonyl)imide anions. In some embodiments, the sodium salt includes sodium cations and fluorinated anions. In some embodiments, the fluorinated anions included in the sodium salt are sulfonamide anions. In some embodiments, the sulfonamide anions included in the sodium salt are bis(trifluoromethanesulfonyl)imide anions. In some embodiments, the ionic liquid electrolyte has a viscosity of up to about 200 mPa s at 22° C. In some embodiments, the viscosity is about 180 mPa s or less, about 160 mPa s or less, about 140 mPa s or less, or about 130 mPa s or less. In some embodiments, the ionic liquid electrolyte has an ionic conductivity of at least about 1.5 mS cm⁻¹ at 25° C. In some embodiments, the ionic conductivity is about 1.7 mS cm⁻¹ or greater, about 2 mS cm⁻¹ or greater, about 2.3 mS cm⁻¹ or greater, or about 2.6 mS cm⁻¹ or greater.

Additional embodiments include a battery comprising an anode, a cathode, and an electrolyte of any embodiment herein disposed between the anode and the cathode. In some embodiments, the anode includes lithium metal.

### First Aspect

In some embodiments, an ionic liquid electrolyte includes lithium cations, sodium cations, organic cations, and fluorinated anions.

In some embodiments of the ionic liquid electrolyte, a concentration of the lithium cations is in a range of greater than about 1 M, such as about 1.1 M or greater, about 1.3 M or greater, about 1.5 M or greater, about 2 M or greater, about 2.5 M or greater, about 3 M or greater, about 3.5 M or greater, about 4 M or greater, about 4.5 M or greater, or about 5 M or greater, and up to about 6 M or greater, or up to about 7 M or greater.

In some embodiments of the ionic liquid electrolyte, a concentration of the sodium cations is in a range of at least about 0.05 M, such as about 0.07 M or greater, about 0.1 M or greater, about 0.13 M or greater, or about 0.16 M or greater, and up to about 0.2 M or greater, up to about 0.3 M or greater, up to about 0.4 M or greater, or up to about 0.5 M or greater.

In some embodiments of the ionic liquid electrolyte, a ratio of the concentration of the lithium cations to the concentration of the sodium cations is in a range of at least about 12, such as about 15 or greater, about 17 or greater, about 20 or greater, about 23 or greater, about 25 or greater, about 27 or greater, or about 30 or greater, and up to about 40 or greater, or up to about 50 or greater.

In some embodiments of the ionic liquid electrolyte, the organic cations include imidazolium cations. In some embodiments, the imidazolium cations include, or are, 1,3-dialkylimidazolium cations, where alkyl substituents may be the same or different. In some embodiments, the 1,3-dialkylimidazolium cations include, or are, 1-ethyl methylimidazolium cations.

In some embodiments of the ionic liquid electrolyte, the fluorinated anions include first fluorinated anions and second fluorinated anions which are different from the first fluorinated anions. In some embodiments, the first fluorinated anions include, or are, first sulfonamide anions, and the second fluorinated anions include, or are, second sulfonamide anions which are different from the first sulfonamide anions. In some embodiments, the first sulfonamide anions include, or are, bis(fluorosulfonyl)imide anions, and the second sulfonamide anions include, or are, bis(trifluoromethanesulfonyl)imide anions. In some embodiments, a concentration of the first sulfonamide anions is greater than a concentration of the second sulfonamide anions. In some embodiments, a ratio of the concentration of the first sulfonamide anions to the concentration of the second sulfonamide anions is in a range of at least about 24, such as about 30 or greater, about 34 or greater, about 40 or greater, about 46 or greater, about 50 or greater, about 54 or greater, or about 60 or greater, and up to about 80 or greater, or up to about 100 or greater. In some embodiments, the concentration of the first sulfonamide anions is in a range of greater than about 2 M, such as about 2.2 M or greater, about 2.6 M or greater, about 3 M or greater, about 4 M or greater, about 5 M or greater, about 6 M or greater, about 7 M or greater, about 8 M or greater, about 9 M or greater, or about 10 M or greater, and up to about 12 M or greater, or up to about 14 M or greater. In some embodiments, the concentration of the second sulfonamide anions is in a range of at least about 0.05 M, such as about 0.07 M or greater, about 0.1 M or greater, about 0.13 M or greater, or about 0.16 M or greater, and up to about 0.2 M or greater, up to about 0.3 M or greater, up to about 0.4 M or greater, or up to about 0.5 M or greater.

In some embodiments of the ionic liquid electrolyte, the ionic liquid electrolyte has a viscosity of up to about 200 mPa s at 22° C., such as about 180 mPa s or less, about 160 mPa s or less, about 140 mPa s or less, or about 130 mPa s or less, and down to about 125 mPa s or less, or down to about 110 mPa s or less.

In some embodiments of the ionic liquid electrolyte, the ionic liquid electrolyte has an ionic conductivity of at least about 1.5 mS cm⁻¹ at 25° C., such as about 1.7 mS cm⁻¹ or greater, about 2 mS cm⁻¹ or greater, about 2.3 mS cm⁻¹ or greater, or about 2.6 mS cm⁻¹ or greater, and up to about 3 mS cm⁻¹ or greater.

### Second Aspect

In some embodiments, an ionic liquid electrolyte includes an ionic liquid, a lithium salt, and a sodium salt.

In some embodiments of the ionic liquid electrolyte, a molar ratio of lithium included in the lithium salt to sodium included in the sodium salt is in a range of at least about 12, such as about 15 or greater, about 17 or greater, about 20 or greater, about 23 or greater, about 25 or greater, about 27 or greater, or about 30 or greater, and up to about 40 or greater, or up to about 50 or greater.

In some embodiments of the ionic liquid electrolyte, the ionic liquid includes organic cations and fluorinated anions. In some embodiments, the organic cations include imidazolium cations. In some embodiments, the imidazolium cations include, or are, 1,3-dialkylimidazolium cations, where alkyl substituents may be the same or different. In some embodiments, the 1,3-dialkylimidazolium cations include, or are, 1-ethyl-3-methylimidazolium cations. In some embodiments, the fluorinated anions include, or are, sulfonamide anions. In some embodiments, the sulfonamide anions include, or are, bis(fluorosulfonyl)imide anions.

In some embodiments of the ionic liquid electrolyte, the lithium salt includes lithium cations and fluorinated anions. In some embodiments, the fluorinated anions include, or are, sulfonamide anions. In some embodiments, the sulfonamide anions include, or are, bis(fluorosulfonyl)imide anions.

In some embodiments of the ionic liquid electrolyte, the sodium salt includes sodium cations and fluorinated anions. In some embodiments, the fluorinated anions include, or are, sulfonamide anions. In some embodiments, the sulfonamide anions include, or are, bis(trifluoromethanesulfonyl)imide anions.

In some embodiments of the ionic liquid electrolyte, the ionic liquid electrolyte has a viscosity of up to about 200 mPa s at 22° C., such as about 180 mPa s or less, about 160 mPa s or less, about 140 mPa s or less, or about 130 mPa s or less, and down to about 125 mPa s or less, or down to about 110 mPa s or less.

In some embodiments of the ionic liquid electrolyte, the ionic liquid electrolyte has an ionic conductivity of at least about 1.5 mS cm⁻¹ at 25° C., such as about 1.7 mS cm⁻¹ or greater, about 2 mS cm⁻¹ or greater, about 2.3 mS cm⁻¹ or greater, or about 2.6 mS cm⁻¹ or greater, and up to about 3 mS cm⁻¹ or greater.

### Third Aspect

In some embodiments, a battery includes an anode, a cathode, and the electrolyte of any of the foregoing embodiments disposed between the anode and the cathode.

In some embodiments of the battery, the anode includes lithium metal.

As used herein, the singular terms “a,” “an,” and “the” include plural referents unless the context clearly dictates otherwise. Thus, for example, reference to an object can include multiple objects unless the context clearly dictates otherwise.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially,” “substantial,” “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

### Examples

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

Below, this disclosure reports, e.g., a lithium metal battery in an ionic liquid (IL) electrolyte comprised of a high-concentration of about 5 M lithium bis(fluorosulfonyl)imide (LiFSI) salt in 1-ethyl-3-methylimidazolium bis(fluorosulfonyl)imide ([EMIm]FSI), with sodium bis(trifluoromethanesulfonyl)imide (NaTFSI) as an additive. Highly reversible and dendrite-free lithium redox is attained with about 99% Coulombic efficiency for 400 cycles. Li anodes paired with lithium cobalt oxide (LiCoO₂) and lithium nickel cobalt manganese oxide (LiNi_{0.8}Co_{0.1}Mn_{0.1}O₂, NCM 811) cathodes exhibit about 99.6-99.9% Coulombic efficiencies, high discharge voltages up to about 4.4 V, and high specific capacity and energy density up to about 199 mAh g⁻¹ and about 765 Wh kg⁻¹, respectively. The relatively low viscosity IL allows useful cathode mass loading up to about 16 mg cm⁻². Typical Li—LiCoO₂ battery retains about 81% of the capacity after 1,200 cycles at about 0.7 C (capacity loss less than about 0.016% per cycle), an impressive performance in ILs. Chemical and morphological analysis indicates synergistic Na⁺ electrostatic shielding and fluorination chemistry for highly reversible lithium metal batteries.

### Properties of HC—LiNa Ionic Liquid Electrolyte:

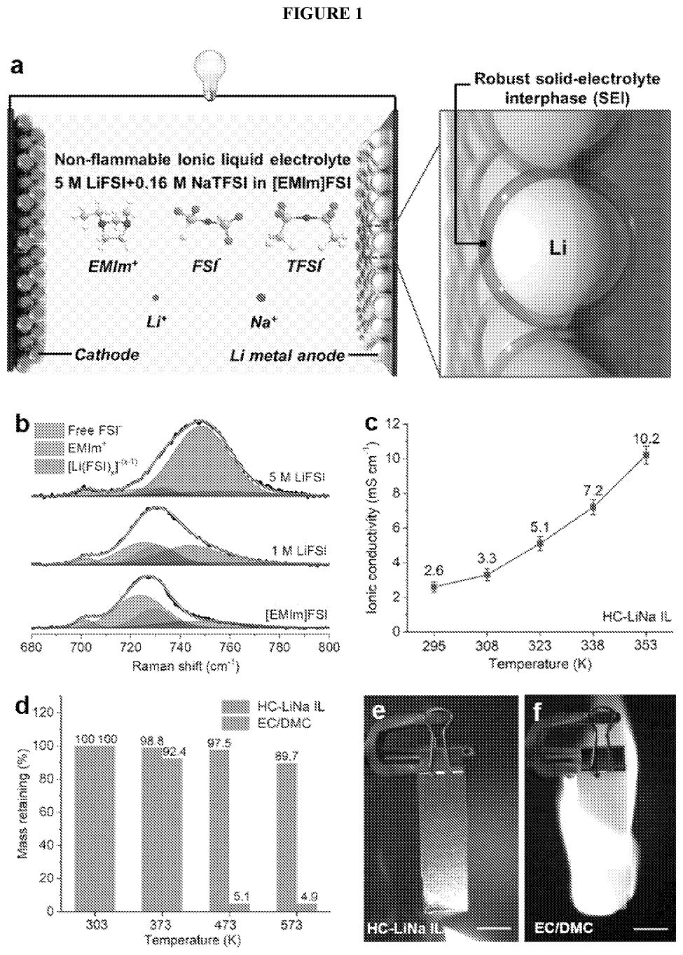

The HC—LiNa IL was prepared by dissolving about 5 M LiFSI salt in [EMIm]FSI, followed by adding about 0.16 M NaTFSI (FIG. 1a, also see Method). As control, about 1 M and about 5 M LiFSI salt were dissolved in [EMIm]FSI to obtain the low and high-concentration LiFSI ILs without NaTFSI, referred to as LC—Li and HC—Li ILs, respectively. The HC—LiNa IL electrolyte exhibited a viscosity of about 125 mPa s at about 22° C., about half of Py13 based ILs. Raman spectroscopy was performed to elucidate speciation in bare [EMIm]FSI, LC—Li and HC—Li ILs (FIG. 1b). The bare [EMIm]FSI showed two Raman peaks at about 726 and about 702 cm⁻¹ assigned to FSI anion and EMIm cation respectively (FIG. 1b). Addition of about 1 M LiFSI resulted in a peak shift from about 726 to about 730 cm⁻¹, indicating [Li(FSI)ₓ]^{-(x-1)} complexes at about 745 cm⁻¹. At a higher LiFSI concentration (about 5 M in about 4.9 M [EMIm]FSI), a more noticeable peak shift to about 748 cm⁻¹ occurred accompanied by a decrease in the peak intensity of “free” FSI anion at about 724 cm⁻¹ (FIG. 1b), indicating a high degree of FSI anion to Li cation coordination in the HC—LiNa electrolyte.

The HC—LiNa IL showed an ionic conductivity of about 2.6 mS cm⁻¹ at about 25° C., which was lower than that of comparative organic electrolyte but exceeded Li-based IL electrolytes (about 1.0-1.2 mS cm⁻¹) comprised of bulky cations such as Py13 and N-methyl-N-butylpyrrolidinium (Py14). At a higher temperature, e.g., about 353 K (about 80° C.), the ionic conductivity increased to about 10.2 mS cm⁻¹ due to a decreased viscosity (FIG. 1c).

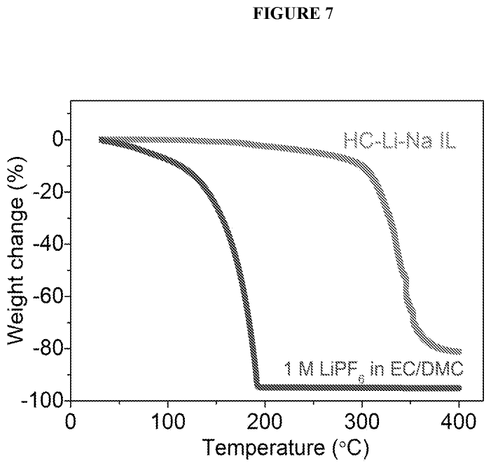

The HC—LiNa IL showed superior thermal stability to organic electrolytes in thermogravimetric analysis (TGA) (FIG. 7). A severe weight loss occurred at about 403 K (about 130° C.) for carbonate-based organic electrolyte, namely 1 M LiPF₆ in ethylene carbonate/dimethyl carbonate (EC/DMC) (about 1:1 by vol.), reaching about 95% loss at about 473 K (FIG. 1d). The HC—LiNa IL showed little weight loss at about 473 K, and retained about 90% of the initial weight even at about 573 K (FIGS. 1d and 7). Non-flammability of the HC—LiNa IL electrolyte was verified by soaking a porous glass fiber membrane in the electrolyte and contacting with flame without causing any ignition (FIG. 1e). Comparative organic electrolyte readily caught fire and burned intensely under the same condition (FIG. 1f).

### Electrochemical Properties of Different Electrolytes in Li—Cu and Li—Li Cells:

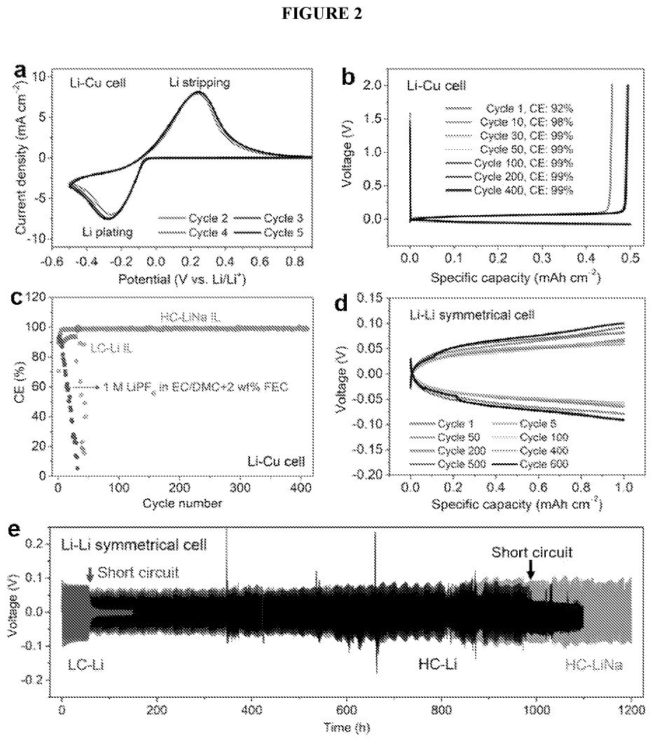

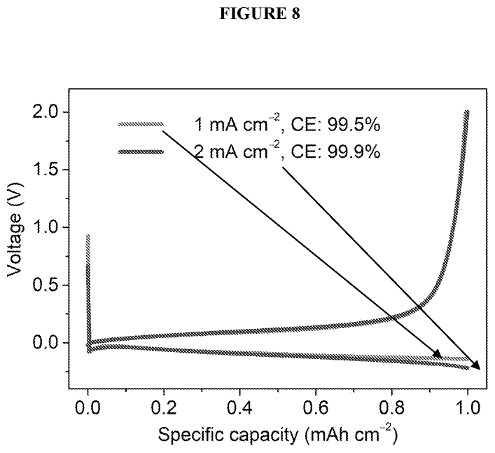

In the HC—LiNa IL electrolyte, cyclic voltammetry (CV) of a Li—Cu cell revealed a pair of reduction/oxidation peak at about −0.27 V/about 0.24 V vs. Li/Li⁺ (FIG. 2a, at a scan rate of about 2 mV s⁻¹), with high reversibility in Li plating/stripping over cycling (FIG. 2a). Under a plating current density and specific capacity of about 0.5 mA cm⁻² and about 0.5 mAh cm⁻² respectively, CE for Li redox in HC—LiNa electrolyte increased from about 92% to about 98% in the first 10 cycles to form a solid-electrolyte interphase (SEI), and then stabilized at about 99% for over 400 cycles (FIGS. 2b and 2c). The high CE of reversible Li redox well exceeded in other Li-based IL electrolytes under similar testing conditions (Table 1). In stark contrast, the Li—Cu cell in LC—Li IL electrolyte showed a much lower 1^{st} cycle CE of about 71%, reached just about 93-94% over about 30 cycles (FIG. 8), and then short circuited with a rapid decrease of CE to about 20% (FIG. 2c). In an organic electrolyte of about 1 M LiPF₆ in EC/DMC (about 1:1 by vol.) with about 2 wt. % fluoroethylene carbonate (FEC), a 1^{st} cycle CE of about 93% was reached but continuously decayed below about 10% in about 30 cycles (FIG. 2c).

TABLE 1
Li plating/stripping Coulombic efficiency at room temperature using different IL electrolytes

| | | | Current | Areal | |
|---|---|---|---|---|---|
| | | | density | capacity | Cyclic |
| Substrate | Electrolyte | CE | (mA cm⁻²) | (mAh cm⁻²) | stability |
| Tungsten | 1.5:1.0:0.1 AlCl₃:[EMIm]Cl:LiCl | 19% | 0.64 | ~1.07 | — |
| Tungsten | 1.5:1.0:0.1 AlCl₃:[EMIm]Cl:LiCl | 33% | 0.64 | ~0.53 | — |
| Tungsten | 1.1:1.0:0.1 AlCl₃:[EMIm]Cl:LiCl | 55% | 0.16 | ~0.003 | — |
| Tungsten | 1.1:1.0:0.1 AlCl₃:[EMIm]Cl:LiCl | 60% | 0.51 | ~0.009 | — |
| Tungsten | 1.1:1.0:0.1 AlCl₃:[EMIm]Cl:LiCl | 80% | 2.55 | ~0.043 | — |
| Tungsten | 1.1:1.0:01 AlCl₃:[EMIm]Cl:LiCl + 68 mM | 71% | 1.2 | 0.04 | — |
| | SOCl₂ | | | | |
| Tungsten | 1.1:1.0:01 AlCl₃:[EMIm]Cl:LiCl + 68 mM | 94% | 3.3 | 0.11 | — |
| | SOCl₂ | | | | |
| Tungsten | 1.1:1.0:01 AlCl₃:[EMIm]Cl:LiCl + 137 mM | 89% | 2 | 0.33 | — |
| | SOCl₂ | | | | |
| Stainless | 1M LiTFSI + 0.1M NaTFSI + 5% VC in | ~90% | 0.1 | ~0.003 | 100 |
| steel | N₁₁₁₄TFSI | | | | cycles |
| Stainless | 1M LiTFSI in N₁₁₁₄TFSI | ~70% | 0.1 | ~0.003 | 100 |
| steel | | | | | cycles |
| Stainless | 1M LiTFSI + 0.1M NaTFSI in N₁₁₁₄TFSI | ~68% | 0.1 | ~0.003 | 100 |
| steel | | | | | cycles |
| Cu | 5M LiFSI + 0.16M NaTFSI in [EMIm]FSI | ~99% | 0.5 | 0.5 | 400 |
| | | | | | cycles |

N₁₁₁₄, trimethylbutylammonium.
TFSI, bis(triflouromethanesulfonyl)imide.
VC, vinylene carbonate.
CE, Coulombic efficiency.

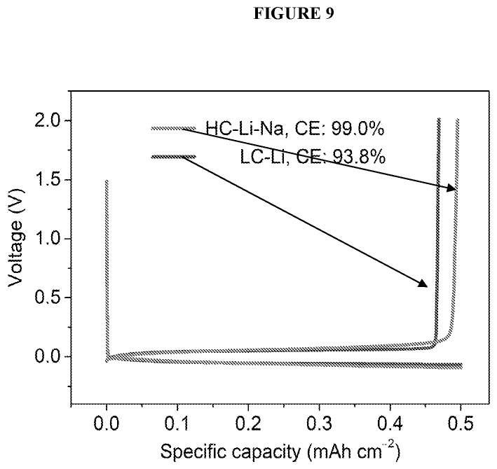

The morphology of the plated Li on Cu after 15 galvanostatic plating/stripping cycles at about 0.5 mA cm⁻² was investigated by scanning electron microscopy (SEM). Dendritic structures were observed in both organic and LC-IL electrolytes, which eventually led to “dead lithium” formation, short circuit and inferior cycling stability (FIGS. 9a-d). In contrast, densely stacked Li particles was observed in HC—LiNa IL electrolyte without noticeable dendritic morphology (FIGS. 9e and 9f).

Symmetrical Li/Li cells under constant current density and specific capacity of about 1 mA cm⁻² and about 1 mAh cm⁻² respectively showed slightly increased polarization during about 1,200 h (600 cycles) of cycling in the HC—LiNa IL electrolyte (FIGS. 2d and 2e). In the LC—Li IL electrolyte, Li anode suffered worse degradation after about 60 h and short circuited (FIG. 2e). The HC—Li IL electrolyte without NaTFSI additive allowed reversible Li plating/stripping but with a shorter cycle life (about 980 h) before short circuiting, indicating the importance of the NaTFSI additive in the HC—LiNa electrolyte (FIG. 2e).

### Li Metal-LiCoO₂ Battery in HC—LiNa Electrolyte:

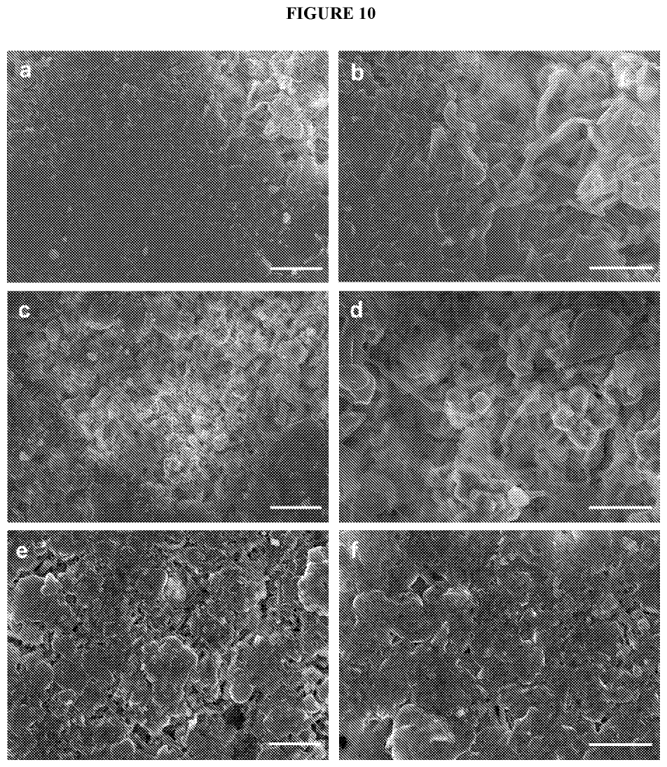

The electrochemical voltage window of the HC—LiNa IL electrolyte was investigated by linear sweep voltammetry in a Li/A1 cell at a scan rate of about 1 mV s⁻¹ (FIG. 10). No noticeable increased oxidation current was observed until about 4.6 V vs. Li/Li⁺, indicating the compatibility of HC—LiNa IL electrolyte for high-voltage Li metal batteries.

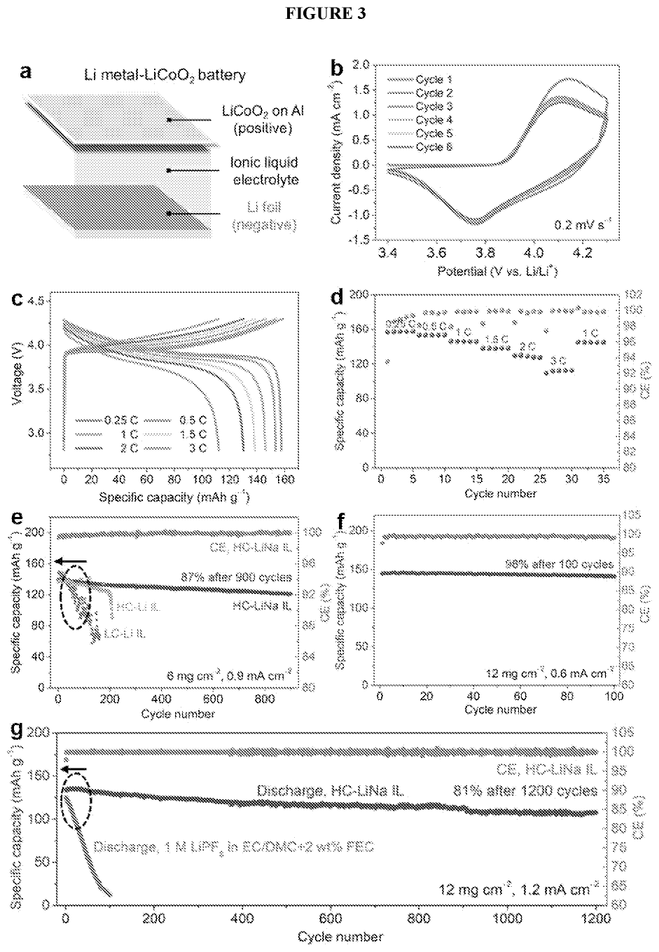

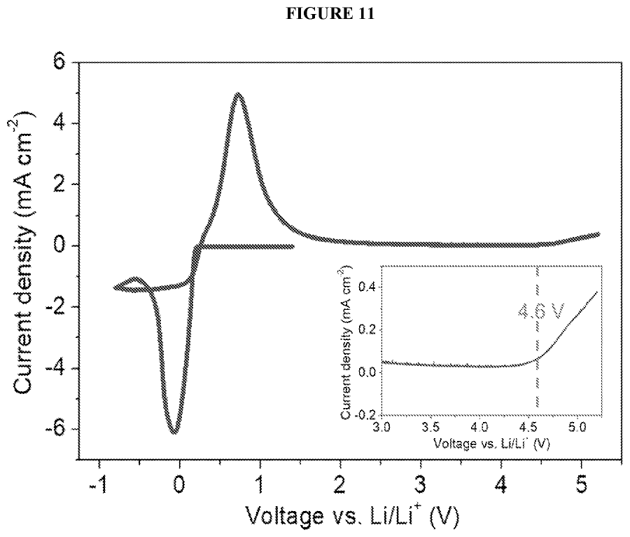

Pairing is made of Li foil anode with LiCoO₂ cathode in the HC—LiNa IL electrolyte (FIG. 3a, also see Method). A LiCoO₂ mass loading of about 6 mg cm⁻² was used unless specified otherwise. CV showed a larger oxidation peak at 1st cycle compared to following cycles due to SEI formation (FIG. 3b). A pair of oxidation/reduction peaks centered at about 4.11 and about 3.76 V corresponded to dilithiation/lithiation of LiCoO₂ (FIG. 3b). The galvanostatic charge-discharge curves of a Li metal-LiCoO₂ battery showed average charge and discharge plateaus at about 4.0 and about 3.9 V, respectively (FIG. 3c). A high specific discharge capacity of about 157 mAh g⁻¹ was delivered at about 0.25 C, corresponding to a high energy density of about 624 Wh kg⁻¹ based on the mass of LiCoO₂. An initial CE of about 93.5% at 1st cycle quickly increased to about 99.0% within three cycles at about 0.25 C and then stabilized at about 99.3% (FIG. 11).

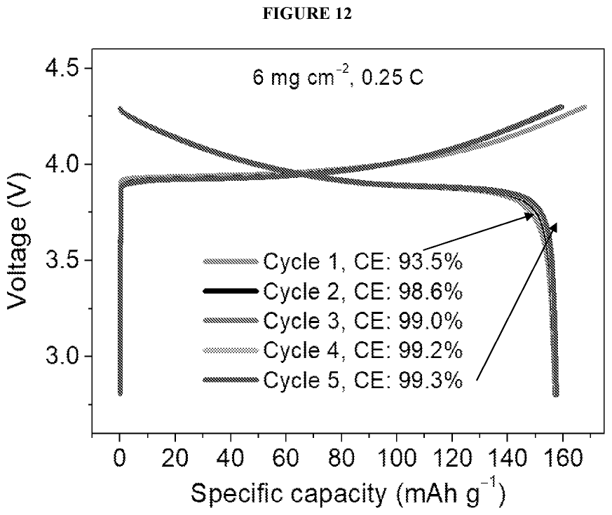

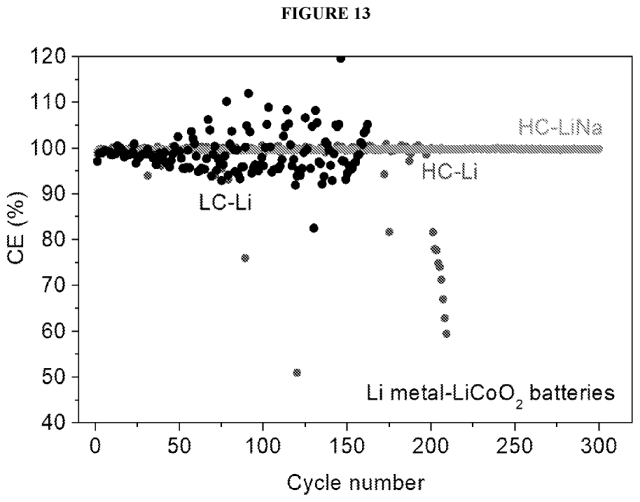

The Li metal-LiCoO₂ batteries with HC—LiNa IL electrolyte also displayed good rate capabilities from about 0.25 to about 3 C, delivering a specific discharge capacity of about 112 mAh g⁻¹ at about 3 C (about 2.6 mA cm⁻²) with a high power density of about 1580 W kg⁻¹ (FIGS. 3c and 3d). Comparison is made of different electrolytes and it is found that for the HC—LiNa IL electrolyte, about 87% of the initial capacity of a Li metal-LiCoO₂ battery was retained for 900 cycles at about 1 C rate (about 140 mA g⁻¹, about 0.9 mA cm⁻²) with a high average CE of about 99.8% (FIG. 3e). The battery using LC—Li IL electrolyte (with about 1 M LiFSI) suffered from rapid capacity decay and retained just about 45% of the initial capacity after 160 cycles (FIG. 3e), accompanied by fluctuating CE after about 50 cycles (FIG. 12). For HC—Li IL electrolyte (no NaTFSI additive), capacity decay occurred after about 200 cycles (FIG. 3e) with sharply decreased CE below about 60% (FIG. 12). Note that adding higher concentration of NaTFSI (e.g., about 0.48 M) than the optimized 0.16 M gave a lower specific capacity and inferior cycling stability after about 160 cycles (FIG. 13).

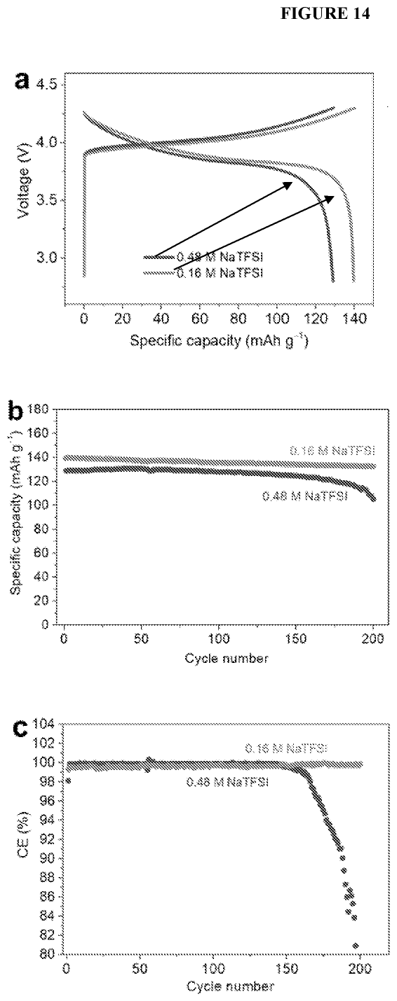

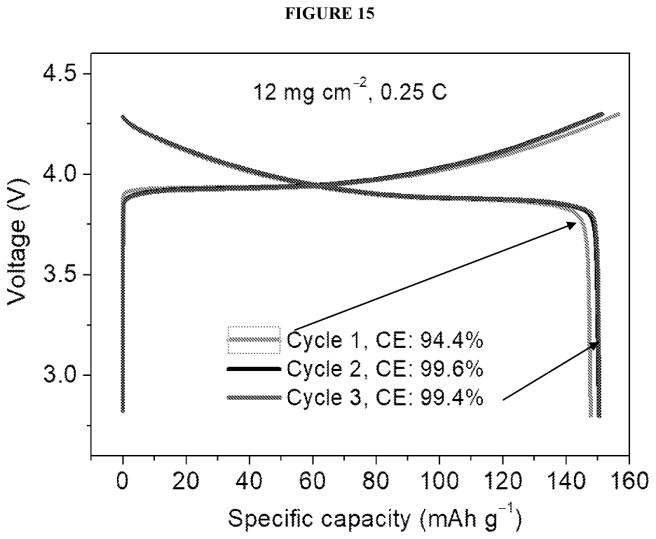

High cathode mass loading is desired for practical battery systems. Increase is made of LiCoO₂ mass loading to about 12 mg cm⁻² and reached a specific discharge capacity of about 152 mAh g⁻¹ at about 0.25 C rate using the HC—LiNa IL electrolyte, corresponding to >about 96% of the capacity of about 6 mg cm⁻² mass loading at the same rate (FIG. 14). When cycled at about 0.35 C (about 50 mA g⁻¹, about 0.6 mA cm⁻²), the Li metal battery with about 12 mg cm⁻² LiCoO₂ mass loading exhibited a high capacity retention of about 98% after 100 cycles with an average CE of about 99.4% (FIG. 3f). At a higher rate of about 0.7 C (about 100 mA g⁻¹, about 1.2 mA cm⁻²), a high cycling stability was observed with about 81% of the initial capacity retained after 1,200 cycles (capacity loss less than about 0.016% per cycle) with an average CE of about 99.9% (FIG. 3g). The HC—Li IL electrolyte could also support stable cycling of Li metal batteries with about 16 mg cm⁻² LiCoO₂ mass loading over 140 cycles at about 0.5 C (about 0.8 mA cm⁻²) with a capacity retention of about 90% and average CE of about 99.8% (FIG. 15). The Li metal-LiCoO₂ batteries based on the HC—LiNa IL electrolyte outperformed other Li metal batteries in IL electrolytes (Table 2).

TABLE 2
Comparison of Li metal-LiCoO₂ batteries using different IL electrolytes

| | | | | | | Discharge | | |
|---|---|---|---|---|---|---|---|---|
| | | Cₛₚ | | Cyclic | Loading | voltage | Eₘₐₓ | Pₘₐₓ |
| Cathode | Electrolyte | (mAh g⁻¹) | CE | stability | (mg cm⁻²) | (V) | (Wh kg⁻¹) | (W kg⁻¹) |
| LiCoO₂ | 0.32M LiTFSI | 133 | >99% | ~90.2%@50 | 3.5 | ~3.9 | ~519 | ~65 |
| | in [DMPIm]TFSI | | | cycles | | | | |
| | | | | ~85.0%@100 | | | | |
| | | | | cycles | | | | |
| LiCoO₂ | ~0.4M LiTFSI | ~133 | — | ~96%@50 | — | ~3.9 | ~519 | ~52 |
| | in Py13FSI | | | cycles | | | | |
| LiCoO₂ | ~0.4M LiTFSI | ~130 | — | ~77%@50 | — | ~3.9 | ~507 | ~51 |
| | in [EMIm]FSI | | | cycles | | | | |
| LiCoO₂ | ~0.46M LiTFSI | ~141 | — | ~89%@50 | 1 | ~3.9 | ~550 | ~55 |
| | in PP13TFSI | | | cycles | | | | |
| LiCoO₂ | ~0.46M LiTFSI | ~132 | — | ~77%@30 | 1 | ~3.9 | ~515 | ~52 |
| | in [EMIm]TFSI | | | cycles | | | | |
| LiCoO₂ | ~0.46M LiTFSI | ~115 | — | ~106%@50 | 1 | ~3.9 | ~450 | ~45 |
| | in [N5555]TFSI | | | cycles | | | | |
| LiCoO₂ | ~0.46M LiTFSI | ~132 | — | ~83%@50 | 1 | ~3.9 | ~515 | ~52 |
| | in [PP13]TSAC | | | cycles | | | | |
| LiCoO₂ | ~0.46M LiTFSI | ~108 | — | ~88%@25 | 1 | ~3.9 | ~421 | ~42 |
| | in [EMIm]TSAC | | | cycles | | | | |
| LiCoO₂ | 0.32 mol/kg | ~124 | ~96% | 86%@50 | — | ~3.9 | ~484 | — |
| | LiTFSI in | | | cycles | | | | |
| | [EMIm]FSI | | | | | | | |
| LiCoO₂ | 0.32 mol/kg | ~130 | >99.5% | 93%@50 | — | ~3.9 | ~507 | ~390 |
| | LiTFSI in | | | cycles | | | | |
| | [DMPIm]FSI | | | | | | | |
| NCM | 1.2M LiFSI | ~136 | — | ~95%@25 | 3 | ~3.75 | ~510 | ~1400 |
| 111 | in Py13FSI | | | cycles | | | | |
| NCM | 4.2M LiFSI | ~215 | — | ~70%@1000 | ~6 | ~3.8 | ~817 | ~850 |
| 811 | in Py13FSI | | | cycles | | | | |
| LiCoO₂ | 5M LiFSI + 0.16M | ~157 | 99.8% | ~87%@900 | 6 | 3.9 | ~624 | ~1580 |
| | NaTFSI in | | | cycles | | | | |
| | [EMIm]FSI | | | | | | | |
| LiCoO₂ | 5M LiFSI + 0.16M | ~152 | 99.9% | ~81%@1200 | 12 | 3.9 | ~618 | ~1200 |
| | NaTFSI in | | | cycles | | | | |
| | [EMIm]FSI | | | | | | | |
| NCM | 5M LiFSI + 0.16M | ~199 | 99.6% | ~94%@200 | 10 | ~3.85 | ~765 | ~1600 |
| 811 | NaTFSI in | | | cycles | | | | |
| | [EMIm]FSI | | | | | | | |

Cₛₚ, CE, Eₘₐₓ and Pₘₐₓ represent specific discharge capacity, Coulombic efficiency, maximal energy density and power density, respectively. DMPIm, 1,2-dimethyl-3-propylimidazolium. EMIm, 1-ethyl-3-methylimidazolium. Py13, N-methyl-N-propylpyrrolidinium. Py14, N-methyl-N-butylpyrrolidinium. PP13, N-methyl-N-propylpiperidinium. N5555, tetraamyl(pentyl)ammonium. FSI, bis(fluorosulfonyl)imide. TFSI, bis(trifluoromethanesulfonyl)imide. TSAC, 2,2,2-trifluoro-N-(trifluoromethyl sulfony)acetamide.

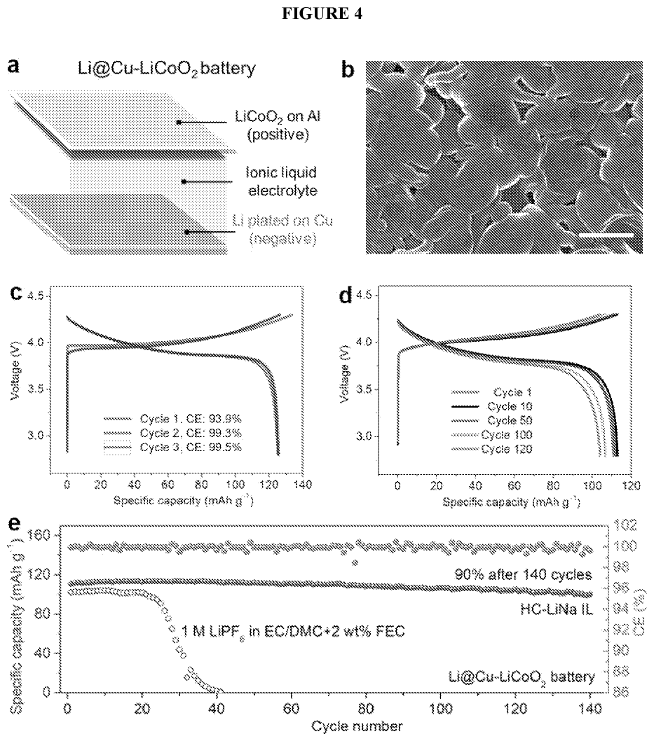

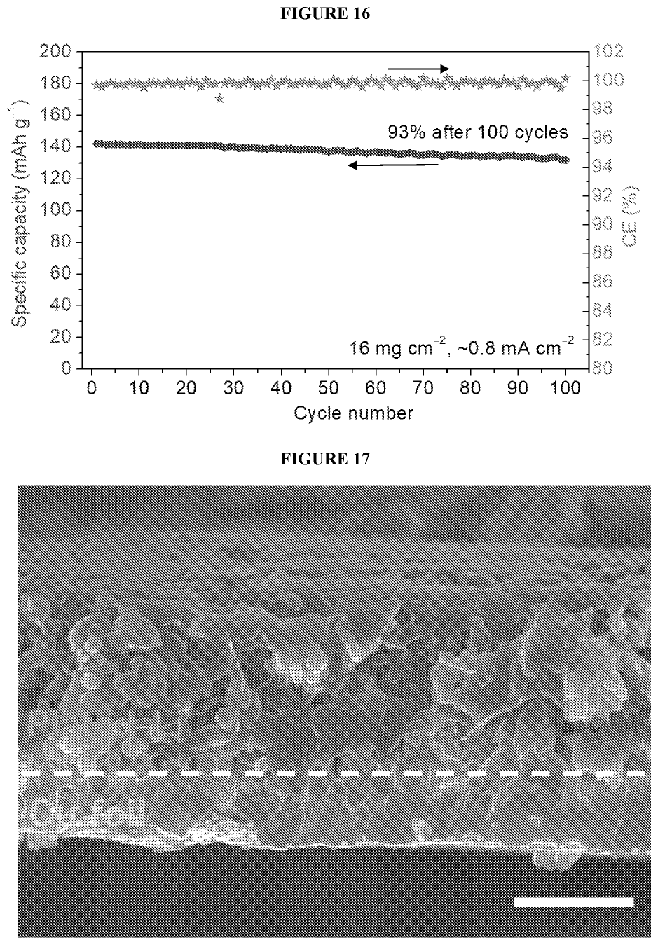

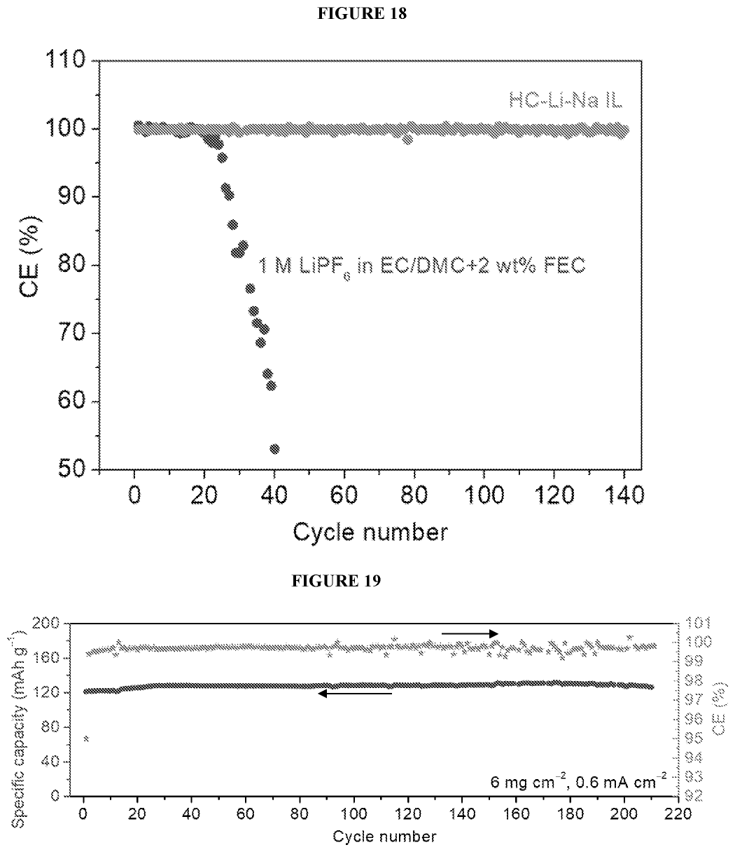

Li metal-LiCoO₂ batteries were further pursued with metallic Li deposited on Cu foil as the negative electrode (referred to as Li@Cu, about 2 times in excess in capacity) (FIG. 4a, b and FIG. 16). When paired with a LiCoO₂ positive electrode (LiCoO₂ mass loading of about 10 mg cm⁻²) in the HC—LiNa IL electrolyte, the battery delivered a specific discharge capacity of about 126 mAh g⁻¹ at about 0.25 C based on the total mass of positive and negative electrodes, corresponding to a maximal energy density of about 490 Wh kg⁻¹ with CE reaching about 99.5% within the first 3 cycles (FIG. 4c). Galvanostatic charge-discharge curves showed no noticeable increase in polarization over about 140 cycles at about 0.7 C rate (about 1 mA cm⁻²) (FIG. 4d) with a high average CE of about 99.9% (FIG. 4e). With a LiCoO₂ mass loading of about 6 mg cm⁻², further improved stability was achieved with stable charge-discharge over 210 cycles at about 0.7 C rate (about 0.6 mA cm⁻²) without noticeable capacity decay (FIG. 17). In comparison, Li@Cu—LiCoO₂ battery using comparative organic electrolyte (about 1 M LiPF₆ in EC/DMC with about 2 wt. % FEC) showed sharp capacity and CE decays after just about 25 cycles (FIG. 4e and FIG. 18).

Li Metal-NCM 811 Battery with High Capacity:

Lithium nickel cobalt manganese oxide represents an important class of cathode material for high energy density, next-generation battery systems. Among them, the Ni-rich LiNi_{0.8}Co_{0.1}Mn_{0.1}O₂ (NCM 811) is the most promising relative to NCM 622, NCM 532 and NCM 111 due to lower cost and higher energy density. It still remains challenging to attain long cyclic life for NCM 811 cathode in various electrolytes. NCM 811 positive electrodes in organic electrolytes also suffer from safety concerns due to thermally induced phase transition to spinel and rock-salt structures when overcharged, releasing oxygen and risking thermal runaway and fire hazards. These challenges have prevented NCM 811 from practical battery applications.

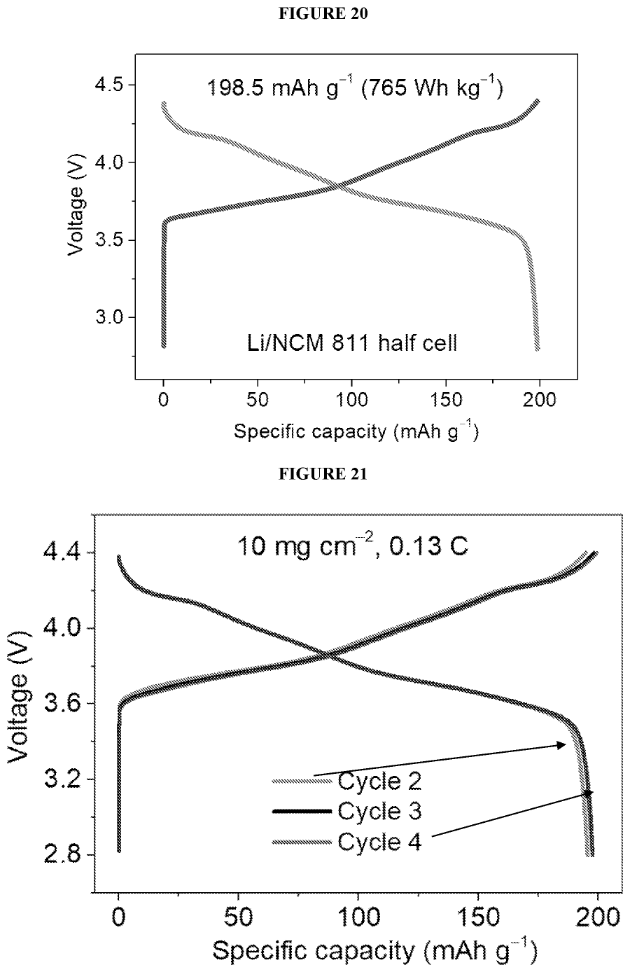

Pairing is made of NCM 811 positive electrode (mass loading of about 10 mg cm⁻²) with Li foil or Li@Cu negative electrode in HC—LiNa IL (FIG. 5a). The battery delivered a specific discharge capacity of about 199 mAh g⁻¹ at about 0.13 C with CE of about 99.5%, corresponding to a high energy density of about 765 Wh kg⁻¹ based on the mass of NCM 811 (FIG. 19). The highest charge and discharge voltages reached about 4.4 V. At a higher rate of about 1 C, the battery delivered a specific capacity of about 162 mAh g⁻¹, about 81% of that at about 0.13 C (FIG. 5b). The battery retained about 94% capacity over 200 cycles at about 0.5 C rate (about 1 mA cm⁻²) with average CE of about 99.6% (FIG. 5c). In contrast, about 29% of the capacity was retained in organic electrolyte composed of about 1 M LiPF₆ in EC/DMC (about 1:1 by vol.) with about 2 wt. % FEC (FIG. 5c). At a higher rate of about 0.7 C, the Li metal-NCM 811 battery retained about 74% of the initial capacity over 500 cycles with average CE of about 99.8% (FIG. 20).

With about 1.8 times excess Li plating on a Cu foil, a Li@Cu-NCM 811 full battery in HC—LiNa IL electrolyte delivered a specific capacity and energy density of about 161 mAh g⁻¹ and about 620 Wh kg⁻¹ at about 0.13 C, respectively, based on the total mass of positive and negative electrodes (FIG. 21). The Li@Cu-NCM 811 battery with HC—LiNa IL electrolyte retained about 95% of the initial capacity during 120 cycles with a high average CE of about 99.8% (FIG. 5d). These results were record setting for IL-based Li-NMC811 batteries.

### Morphology of Lithium Plating/Deposition and Solid Electrolyte Interphase Chemistry:

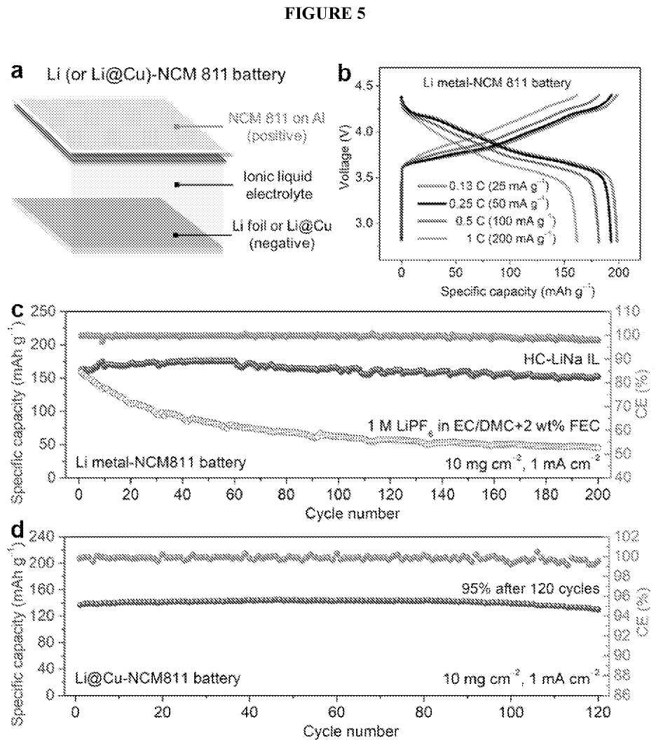

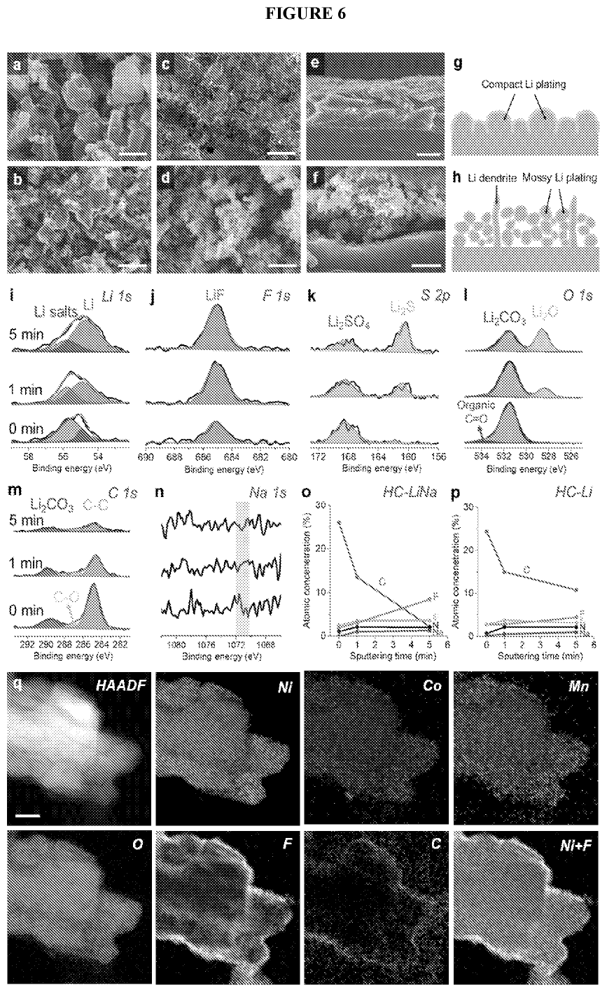

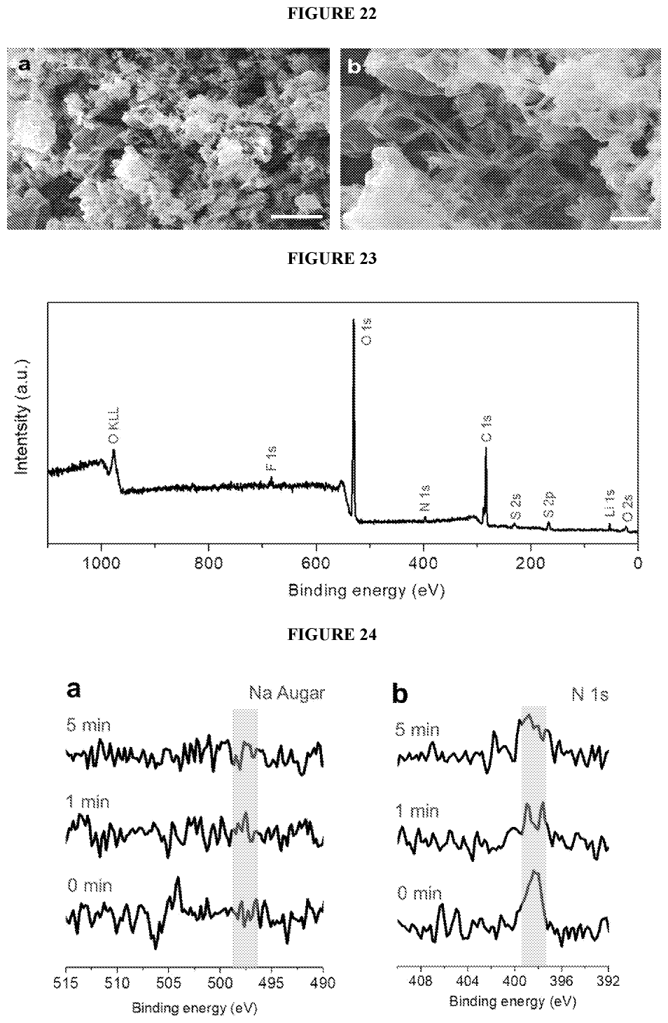

The plated Li morphology in Li metal-LiCoO₂ batteries using different electrolytes was investigated by SEM. Batteries with LiCoO₂ mass loading of about 12 mg cm⁻² were cycled at about 0.7 C (about 1.2 mA cm⁻²) for 20 cycles and stopped at fully charged state before probing the Li negative electrodes. In HC—LiNa IL electrolyte, the plated Li particles showed an average size of about 5 μm without noticeable dendritic morphology (FIG. 6a). In comparison, much smaller sizes (about 1-2 μm) of the plated Li structures were observed in HC—Li IL electrolyte, with the existence of dendrite-like deposits (FIG. 6b and FIG. 22).

Morphology of the plated Li became even more different after long-term cycling, e.g., 400 cycles at about 0.7 C (about 1.2 mA cm⁻²) in HC—LiNa and HC—Li IL electrolytes. A rather compact Li plating layer was observed in HC—LiNa IL electrolyte (FIG. 6c, e), sharply different from the mossy Li plating layer comprised of tiny Li segments (FIG. 6d, f) resulting in the HC—Li IL electrolyte. The compact Li plating and intimate contact with Li foil in HC—LiNa IL facilitated highly reversible Li plating/stripping and long-term cycling (FIG. 6g). The mossy and dendritic morphology of Li plating in HC—Li IL electrolyte led to Li consumption (referred to as “dead lithium”) and continuous electrolyte decomposition at the electrolyte/electrode interphase (FIG. 6h).

A stable solid-electrolyte interphase (SEI), namely a hybrid inorganic/organic layer formed at the electrolyte/Li anode interphase, is important to passivate Li metal and prevent Li from continuous reactions with electrolyte, while allowing Li ions passing through for deposition and dissolution. Investigation is made of the elemental composition and depth profile of the Li metal negative electrodes cycled in HC—LiNa IL electrolyte by X-ray photoelectron spectroscopy (XPS) after Li metal-LiCoO₂ battery cycling (LiCoO₂ mass loading of about 12 mg cm⁻²) at about 0.7 C (about 1.2 mA cm⁻²) for 20 cycles and stopped at fully charged state (FIGS. 6i-n). Surface XPS profile showed Li, F, O, C, S and N (FIG. 23). The co-existence of Li salts and metallic Li was identified by the two fitting peaks at about 55.8 and about 54.8 eV, respectively (FIG. 6i). The pronounced F is peak (about 685.0 eV) at all depths identified LiF as a major component in SEI (FIG. 6j). The high-concentration FSI anions in HC—LiNa was responsible for the F-based SEI resulted from reactions with highly reactive Li metal, with the low-concentration TFSI anion likely making a small contribution. The S 2p peaks at about 168.5 and about 161.0 eV corresponding to Li₂SO₄ and Li₂S decreased and increased in intensity at a larger depth respectively (FIG. 6k), indicating their formation in the SEI due to reactions of FSI/TFSI anions with Li metal. Similar trend was observed for O 1s peaks at about 531.5 and about 528.6 eV, with decreasing and increasing intensity at a larger depth correlating with the distribution of Li₂CO₃ and Li₂O respectively (FIG. 6l). This was also consistent with that the C 1s profile decreased (with Li₂CO₃) at about 289.8 eV (FIG. 6m).

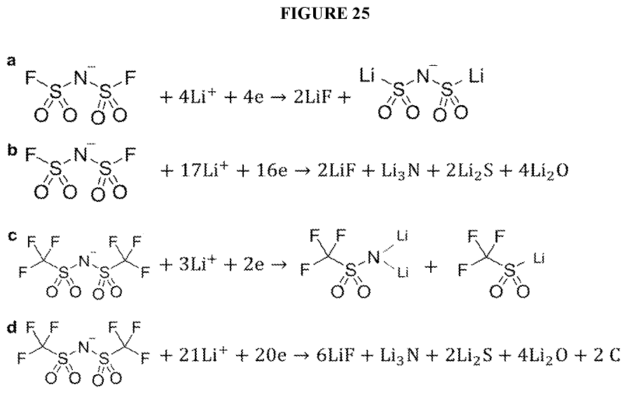

No noticeable Na 1s or Na Auger peaks were observed in the XPS profiles at all depths (FIG. 6n and FIG. 24a), indicating that Na ions in the HC—LiNa IL electrolyte were not co-deposited with Li ions or formed the SEI during the plating process. A weak N 1s peak centered at about 398.3 eV was identified indicating the presence of Li₃N on the surface due to reactions of FSI/TFSI anions with Li metal, and rapidly decreased in intensity at larger depths (FIG. 24b). Overall, a hybrid SEI comprised of LiF, Li₂SO₄, Li₂S, Li₂CO₃, Li₂O, Li₃N and organic species was formed by reactions of the HC—LiNa IL electrolyte with Li metal (FIG. 25).

Further analysis is made of the atomic concentration of various elements on Li metal electrodes in HC—LiNa and HC—Li IL electrolytes at different depths (FIGS. 6o and 6p). For Li anode in the HC—LiNa IL electrolyte, higher F contents were detected at greater depths compared to in HC—Li IL electrolyte, e.g., about 8.4% vs. about 4.4% at about 30 nm depth, indicating a better LiF passivation at Li/electrolyte interphase that contributed to enhanced stability and reversibility. Meanwhile, lower C contents were detected in HC—LiNa IL electrolyte at larger depths, e.g., about 2.2% vs. about 10.8% in HC—Li IL electrolyte, indicating lower C-related components in the inner part of SEI. Similar atomic concentrations of S and N of about 2-4% and about 1-2.2% were detected for Li anodes cycling in the HC—LiNa and HC—Li electrolytes respectively. No appreciable Na (all below about 1.3%) was detected in the SEI from both electrolytes (FIGS. 6o and 6p), indicating that the Na ion in the NaTFSI additive was not involved in SEI formation.

### Cathode Electrolyte Interphase Chemistry:

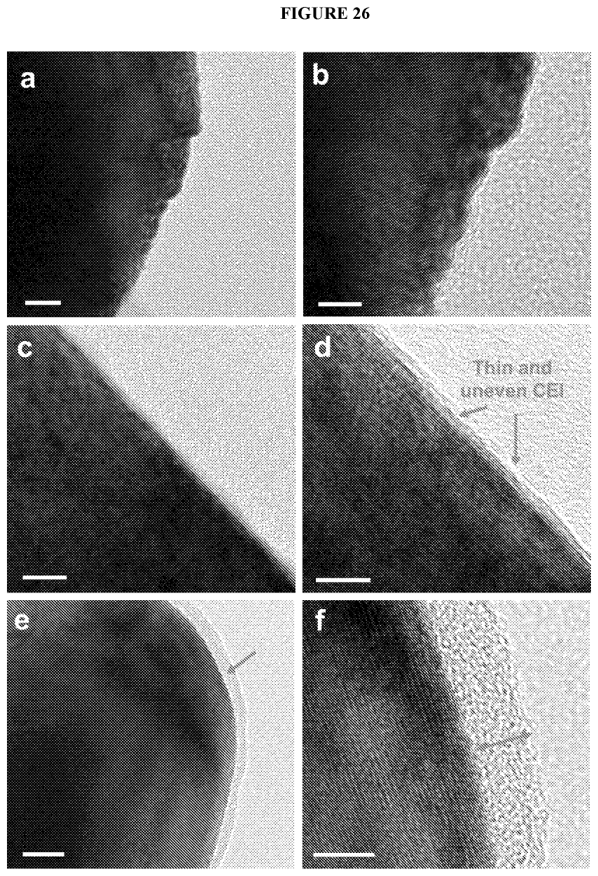

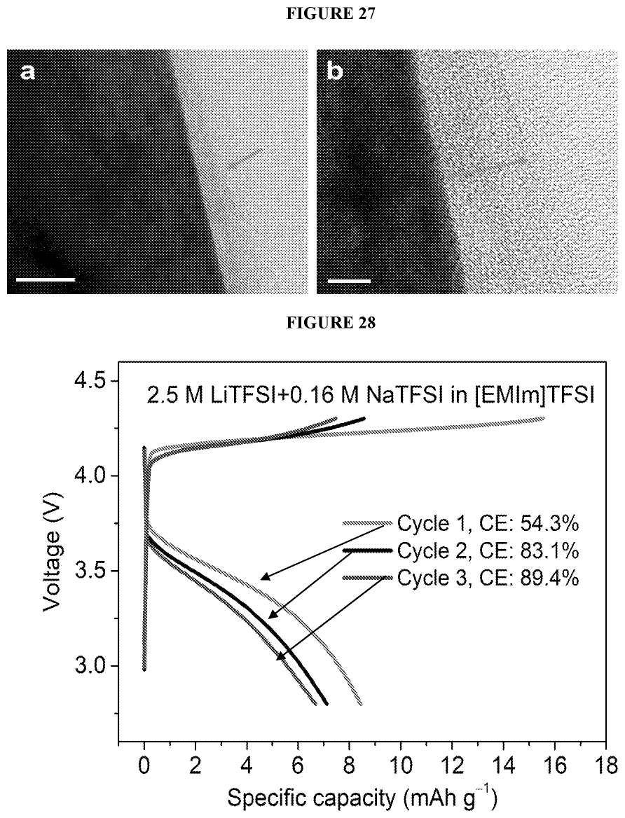

On the positive electrode side, the oxidation of electrolyte could form a passivation cathode-electrolyte interphase (CEI), preventing sustained electrolyte oxidation at high voltage. For Ni-rich cathodes such as NCM 811, this passivation CEI suppressed Ni dissolution into electrolyte and contributed to prolonged cycling stability. Transmission electron microscopy (TEM) is used to probe pristine NCM 811 particles from positive electrodes without cycling, and compared with the ones from Li metal-NCM 811 batteries (NCM 811 mass loading of about 10 mg cm⁻²) cycled at about 0.5 C for 100 cycles in LC—Li and HC—LiNa IL electrolytes, respectively. While the pristine one showed a smooth surface (FIGS. 26a and 26b), the one after cycling in the LC—Li IL electrolyte showed an ultrathin (about 1 nm) and uneven coating layer (FIGS. 26c and 26d). In contrast, a uniform coating layer with thickness of about 5-10 nm was formed on the surface of NCM 811 after cycling in the HC—LiNa IL electrolyte, indicating a denser advantageous CEI layer for suppressing side reactions between cathode/electrolyte (FIGS. 26e and 26f). For LiCoO₂ cathode, a CEI layer with thickness of about 6-10 nm was also observed after cycling in the HC—LiNa IL electrolyte (FIG. 27).

Spatially resolved element mapping analysis of NMC811 cathode particles after battery cycling in HC—LiNa IL at about 0.5 C for 100 cycles by scanning transmission electron microscopy (STEM) identified Ni, Co, Mn and O (FIG. 6q and Table 3). The strong F signal (about 14.7 wt. %) mainly showed distribution in the region near the surface that was clearly seen in the overlapping image with Ni, indicating reactions between FSI/TFSI anions and NCM 811 surface during cycling. As a good electronic insulator with high anodic stability, the fluorine-rich CEI could efficiently prevent continuous reactions between cathode/electrolyte. Similarly, the C signal (about 4.0 wt. %) detected near the surface could be assigned to Li₂CO₃ and organic compounds that were derived from the decomposition of FSI/TFSI and EMIm compounds (FIG. 6q). The weak N and S signals (about 1.0 wt % and about 0.5 wt %) could be assigned to LiₓNO_{y}, and LiₓSO_{y} that were mainly derived from the decomposition of FSI/TFSI anions. It also indicated that no extensive decomposition of EMIm anion on cathode occurred at high voltage up to about 4.4 V due to the passivation of CEI. Overall, the insoluble species (LiF, Li₂CO₃, organic compounds, LiₓSO_{y}, LiₓNO_{y}, and so forth) generated from the reactions between FSI/TFSI anions and NCM 811 formed a robust protection interphase on cathode that contributed to excellent cycling stability of Li metal batteries using NMC811 as the high capacity/energy cathode.

TABLE 3
Mass fraction of the main elements of NCM 811 particles
after cycling in a Li metal-NCM 811 battery

| Element | Mass Fraction (%) | Mass Error (%) |
|---|---|---|
| Ni | 40.16 | 6.38 |
| Co | 5.10 | 0.81 |
| Mn | 4.03 | 0.64 |
| O | 30.18 | 6.58 |
| F | 14.69 | 3.22 |
| C | 4.04 | 0.35 |
| N | 1.02 | 0.23 |
| S | 0.49 | 0.10 |

Before characterization, the battery was cycled in HC—LiNa IL electrolyte at about 0.5 C (about 1 mA cm⁻²) for 100 cycles. NCM 811 mass loading: about 10 mg cm⁻².

### Discussion:

The HC—LiNa IL electrolyte is interesting in several aspects. First, the high concentration (about 10 M) of FSI anions in HC—LiNa IL electrolyte contributed to more aggressive fluorination chemistry that formed uniform fluorine-rich passivation layers at both cathode/electrolyte and anode/electrolyte interphases, which contributed to high-efficiency Li and positive electrode redox cycling. High concentration of Li salts are used in organic electrolytes for stabilizing Li ion batteries. LiF-rich SEI is considered as an ideal electronic insulator that blocks electron tunneling, a major cause for sustained electrolyte consumption and capacity loss. The high interfacial energy between LiF and Li tends to guide a parallel Li growth rather than vertical plating, leading to reduced specific surface area and minimal parasitic reactions between electrolyte and Li metal, thus contributing to higher reversibility and cycling stability. Highly concentrated LiFSI is found efficient to passivate Li metal in ether and carbonate based organic electrolytes by forming a robust SEI with fluorine-rich species. To verify the beneficial FSI anion effect in IL electrolyte, fabrication is made of Li metal-LiCoO₂ batteries using IL electrolyte composed of TFSI anions, namely about 2.5 M LiTFSI+about 0.16 M NaTFSI in [EMIm]TFSI, observing low specific capacity, low CE and large overpotential (FIG. 28).

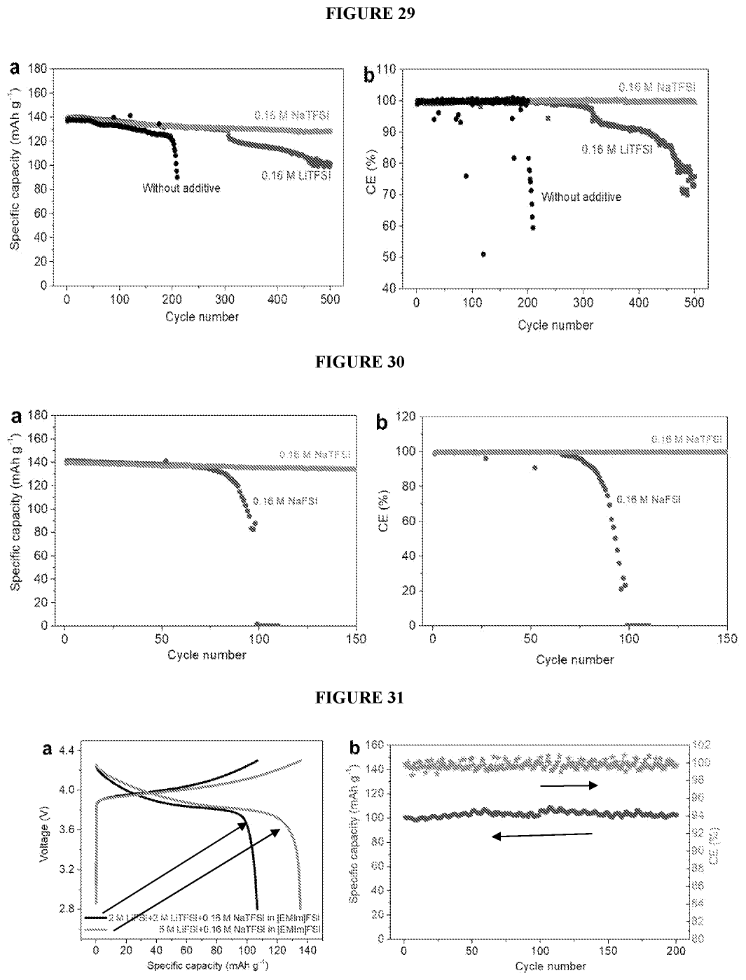

Second, it is found that although high-concentration LiFSI salt contributed to enhanced stability, NaTFSI additive was highly beneficial for dense Li plating, robust SEI and high cycling stability. Both Na ion and TFSI anion were important. Replacing NaTFSI with equal amount of LiTFSI (about 0.16 M) resulted in inferior cycling stability after about 300 cycles with decreased specific capacity and CE, indicating that Na ion facilitated stabilizing cycling performance (FIG. 29). With weak Na signal in the anode probed by XPS depth profiling, Na ions neither co-deposited with Li nor participated in SEI formation, but were likely to provide a positively charged electrostatic shielding around the initial growth tip of the Li protuberances, which can suppress dendrite growth as for Cs and Rb ions.

To confirm the role of TFSI anion, comparison is made of the battery performances in IL electrolytes with the same amount of NaFSI or NaTFSI additives. Battery with NaFSI additive performed stably for just 65 cycles, inferior to NaTFSI additive (FIG. 30). The importance of TFSI anion additive to the LiFSI dominant IL was consistent with that the combination of FSI and TFSI compounds in organic electrolyte formed a more robust SEI than FSI or TFSI anion alone. Of note is that in the HC—LiNa IL electrolyte, the optimal TFSI anion concentration was much lower in concentration than FSI anions. Replacing about 5 M LiFSI with the mixture of about 2 M LiFSI and about 2 M LiTFSI in the IL electrolyte reduced the specific capacity of the Li metal-LiCoO₂ battery by over about 21% at about 0.7 C, although a good capacity retention could be achieved within 200 cycles (FIG. 31).

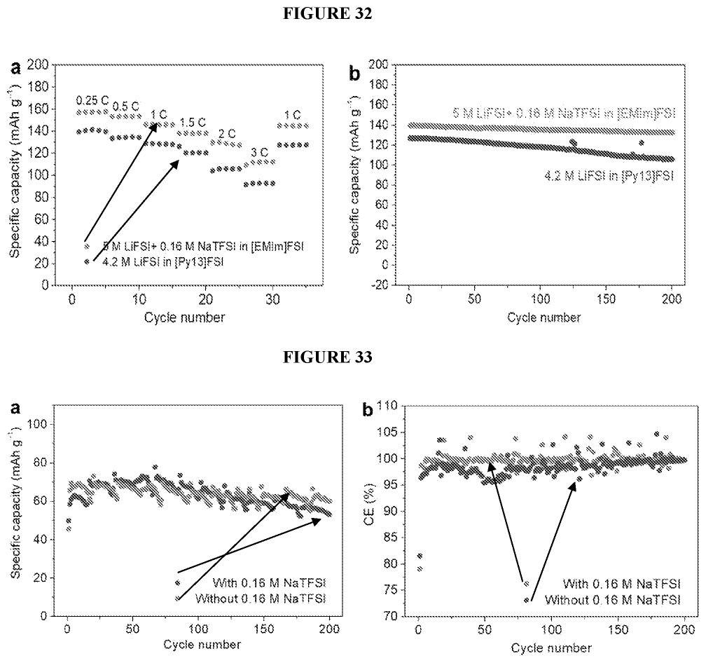

Third, the EMIm cation in the HC—LiNa IL electrolyte was important. The imidazolium-based EMIm cation exhibited a lower electrochemical voltage window (about 4.2-4.3 V) than quaternary ammonium, piperidinium and pyrrolidinium cations. Consequently the family of EMIm cation based ILs are not in the mainstream of Li-based IL electrolyte. Nevertheless, imidazolium based ILs generally exhibited the lowest viscosities due to the delocalized positive charge around the imidazolium ring that effectively increased the cation/anion distance and reduced the electrostatic interaction between ion pairs. Indeed, the HC—LiNa IL electrolyte showed a lower viscosity of about 125 mPa s compared to about 240 mPa s of about 4.2 M LiFSI in Py13FSI IL electrolyte at room temperature. Lower viscosity afforded higher ionic conductivity, promoted electrolyte permeation into high mass loading electrode, and enhanced rate capability. The HC—LiNa IL showed a higher ionic conductivity of about 2.6 mS cm⁻¹ than about 1.2 mS cm⁻¹ for about 4.2 M LiFSI in Py13FSI IL electrolyte, leading to higher rate capability of Li metal-LiCoO₂ batteries in HC—LiNa IL electrolyte (FIG. 32a). The effective passivation on both negative and positive electrodes in the HC—LiNa IL electrolyte also contributed to better battery cycling stability than in about 4.2 M LiFSI in Py13FSI electrolyte (about 95% vs. about 84% after 200 cycles at about 1 C) (FIG. 32b).

Lower viscosity electrolyte allowed for higher loading of cathode materials for practical batteries. For instance, at about 10 mg cm⁻² mass loading of NCM 811 cathode, a low specific capacity (about 65 mAh g⁻¹) was demonstrated with the viscous about 4.2 M LiFSI/Py13FSI IL at about 0.5 C (about 1 mA cm⁻²), which was about 40% of the capacity (about 175 mAh g⁻¹) attained in the HC—LiNa IL electrolyte (FIG. 33). Notably, the average CE of about 98.5% was also lower compared with about 99.6% derived from the HC—LiNa IL electrolyte. Low mass loading (about 6 mg cm⁻²) of NCM 811 is demonstrated in a comparative approach for about 4.2 M LiFSI in Py13FSI IL electrolyte.

### Conclusions:

In this disclosure, development is made of a non-flammable ionic liquid electrolyte towards high-safety and high-energy lithium metal batteries. Comprised of high-concentration LiFSI and small amount NaTFSI additive in [EMIm]FSI, the ionic liquid electrolyte allows high Coulombic efficiency for Li plating/stripping. Li negative electrodes coupled with LiCoO₂ or LiNi_{0.8}Co_{0.1}Mn_{0.1}O₂ positive electrode in the electrolyte lead to high Coulombic efficiency (about 99.6-99.9%), high discharge voltages up to about 4.4 V, and high specific capacity and energy density up to about 199 mAh g⁻¹ and about 765 Wh kg⁻¹ respectively. High LiCoO₂ mass loading of about 12-16 mg cm⁻² was possible, and the batteries show an impressive cycling stability >1,200 cycles. Probing the morphology and interphase chemistry in the ionic liquid electrolyte reveals a synergistic electrostatic shielding and fluorination chemistry mechanism for the impressive battery performances. These findings could encourage further development of electrolyte systems for high safety, high energy density and long cycle life battery systems.

### Methods

Preparation of IL and organic electrolytes. IL electrolytes were prepared in an argon (Ar)-filled glove box with water and oxygen content below about 1 ppm. LiFSI (about 99%, Henan Tianfu Chemical), NaFSI (TCI America), LiTFSI (Sigma-Aldrich) and NaTFSI (Alfa Aesar) were dried at about 120° C. for about 10 h under vacuum before use. The synthesis of [EMIm]FSI is described herein. IL electrolytes were prepared by dissolving LiFSI salt with [EMIm]FSI under stirring for about 2 h, followed by adding NaTFSI or LiTFSI additive and stirring for about 4 h. The obtained IL electrolytes were kept at about 80° C. for about 30 min under vacuum for water removal before use. The water contents of IL electrolytes were below about 20 ppm (Karl Fischer titration method). About 1 M LiPF₆ in ethylene carbonate (EC) and dimethyl carbonate (DMC) (about 1:1 by vol.) (battery grade, Sigma-Aldrich) with and without about 2 wt. % fluoroethylene carbonate (about 99%, anhydrous, Sigma-Aldrich) was used as organic electrolytes for comparison. About 1 M LiTFSI in 1,3-dioxolane (DOL, about 99.8%, anhydrous, Sigma-Aldrich)/1,2-dimethoxyethane (DME, about 99.5%, anhydrous, Sigma-Aldrich) (about 1:1 by weight) with about 1 wt. % LiNO₃ (99%, Alfa Aesar) was prepared as the electrolyte for Li plating on Cu foil.

Preparation of LiCoO₂ and NCM 811 positive electrodes. LiCoO₂ (MTI) and NCM 811 (Shanshan Tech) powder were dried at about 100° C. for about 8 h under vacuum before use. To prepare slurries, about 80 wt. % LiCoO₂ powder was mixed with about 10 wt. % conductive carbon black (Super C65, Timical) and about 10 wt. % polyvinylidene fluoride (PVDF, M_{w}=about 180,000, Sigma-Aldrich) in N-methyl-2-pyrrolidone (NMP, about 99.5%, Sigma-Aldrich). The weight ratio of LiCoO₂, carbon black and PVDF was about 92:4:4 for making electrodes with LiCoO₂ mass loading of about 12 and about 16 mg cm⁻² (about 1.7 mAh cm⁻²). The dispersion was stirred for about 10 h to obtain a viscous and uniform slurry, and coated on Al foil (about 20 μm, Ubiq Tech. Inc. LTD) using a film applicator (Model 510, Erichsen). The obtained positive electrodes were further pressed under a pressure of about 1000 kg cm⁻² to achieve a high volume density and good adhesion to substrate, followed by drying at about 120° C. under vacuum for about 12 h. The NCM 811 electrodes (NCM 811 mass loading of about 10 mg cm⁻²) were prepared using the same procedure with the weight ratio of NCM 811, conductive carbon and PVDF setting as about 80:10:10. For electrodes used for Li@Cu-NCM 811 batteries, the weight ratio of NCM 811, conductive carbon and PVDF was set as about 90:5:5.

Preparation of electroplating Li on Cu foil. Electrodeposited Cu foil (CF-T8G-UN; Pred. Materials International, Inc.) with a thickness of about 15 μm was sonicated in ethanol and then dried under vacuum at about 80° C. The electrochemical plating of Li was performed in a 2032 type coin cell with Cu and Li foils as positive and negative electrodes, respectively. Polypropylene (Celgard 2500) and glass fiber (Whatman GF/A) separators were absorbed with about 160 μL electrolyte composed of about 1 M LiTFSI in DOL/DME (about 1:1 by weight) with about 1 wt. % LiNO₃. Before Li plating, the cell was pre-cycled for four cycles between about 0.01 and about 0.5 Vat about 0.1 mA for removal of possible impurity and oxidation layer on the surface of electrode. A constant current density of about 0.3 mA cm⁻² was then applied for Li plating with controlled duration for capacity control. The Li@Cu foil was taken out of the coin cell and washed with the DOL/DME mixture (about 1:1 by weight) for 3 times, followed by removing the residual solvent under vacuum for about 20 min.

Electrochemical measurement. All the electrochemical measurements were performed at room temperature (about 22° C.) unless otherwise specified. The Li plating/stripping performances were measured in 2032-type coin cells. The surface of Li foil (about 99.9%, about 0.38 mm thick, Sigma-Aldrich) was scratched to remove possible oxidation and contamination before use. For investigating the Li plating/stripping CE, a Li and Cu foil were served as negative and positive electrodes, respectively. One layer of glass fiber and polyethylene terephthalate (PET)/Al₂O₃ separator (Separion, Evonik) with about 120 μL electrolyte were used in each cell, which was first pre-cycled for 4 cycles at about 0.1 mA between about 0.01 and about 0.5 V for removal of possible impurity and oxidation layer on electrodes, and galvanostatic Li plating/stripping was performed at desired current densities and capacities. For a symmetrical Li/Li cell, both the positive and negative electrodes were Li foils with the use of about 120 μL electrolyte in each cell. The electrochemical performances of Li metal batteries were measured in pouch-type cells. Briefly, carbon tap (Ted Pella) was used to paste positive electrode (LiCoO₂ or NCM 811 electrodes) and negative electrode (Li foil or Li@Cu foil) onto an aluminum laminated pouch (EQ-alf-400, MTI). Two nickel tabs (EQ-PLiB-NTA3, MTI) and one layer of glass fiber membrane (Whatman GF/A) were used as the current collector and separator, respectively. The obtained pouch was dried at about 80° C. under vacuum for about 12 h prior to transferring into an argon-filled glove box for battery assembling. About 0.3 mL electrolyte was added before heat-sealing each pouch for electrochemical measurement. A CHI760E electrochemical work station was used for cyclic voltammetry measurement. The galvanostatic charge-discharge measurement was conducted on a Neware battery testing system (CT-4008-5V50 mA-164-U) in the voltage range of about 2.8-4.3 V (LiCoO₂) and about 2.8-4.4 V (NCM 811). All the cells were allowed to age for about 6 h before testing. During test, each pouch cell was clamped with two clips (0.5 inch, Clipco) between two hardboards to obtain a small pressure. The corresponding current densities of LiCoO₂ and NCM 811 cathodes at about 1 C were set to about 140 and about 200 mA g⁻¹, respectively. For batteries using Li metal foils, the specific capacity, energy and power densities were calculated based on the mass of LiCoO₂ (or NCM 811). For batteries using Li@Cu foils, the calculation was based on the total mass of positive and negative electrodes.

Characterization. Raman spectra of IL electrolytes were acquired using an Ar ion laser (about 532 nm) with about 0.8 cm⁻¹ resolution, and IL electrolytes were sealed in transparent plastic pouches in an Ar-filled glove box before measurement. The conductivity was measured using an FP30 Mettler Toledo conductivity meter. A Cannon-Ubbelohde semi-micro viscometer (L45) was used to measure the viscosity. TGA was performed on a PerkinElmer/Diamond TG/DTA thermal analyzer at a heating rate of about 5° C. min⁻¹ in nitrogen for IL and organic electrolytes. Before characterization, the battery samples were rinsed with anhydrous DMC for 4 times to remove the residual electrolyte, and dried under vacuum at room temperature, followed by sealing in Ar-filled pouches and quickly transferring into the vacuum chamber for characterization. SEM images were acquired from a Hitachi/S-4800 SEM operated at about 15 kV. XPS spectra were collected on a PHI 5000 VersaProbe Scanning XPS Microprobe. All the binding energy values were calibrated with C1s peak (about 284.6 eV). Depth profile was obtained using Ar ion sputtering at about 2 kV corresponding to a SiO₂ sputter rate of about 6 nm min⁻¹.

Synthesis of 1-ethyl-3-methylimidazolium bis(fluorosulfonyl)imide ([EMIm]FSI). 1-methylimidazole (99%) was provided by Shanghai Holdenchem (Shanghai, China). Bromomethane (about 99%), ethyl acetate (about 99.5%) and dichloromethane (about 99.5%) were purchased from Sinopharm Chemical Reagent (Shanghai, China). About 82 g (about 1 mole) 1-methylimidazole was dissolved in ethyl acetate to obtain a solution. Then, about 130.7 g (about 1.2 mole) bromoethane was dropwisely added into the 1-methylimidazole/ethyl acetate solution at room temperature. The mixture was stirred at room temperature for about 12 h to form a white precipitant ([EMIm]Br) gradually. The [EMIm]Br precipitant was collected by filtration and then rinsed with ethyl acetate. Finally, the [EMIm]Br was dried under vacuum at about 80° C. for about 6 h. [EMIm]Br and LiFSI were respectively dissolved in deionized water to form two kinds of aqueous solutions. Then, those two aqueous solutions were mixed together with a substantially equal mole of [EMIm]Br and LiFSI. After stirring for about 2 h, the aqueous mixture was extracted with dichloromethane. The aqueous mixture/dichloromethane solution was washed with deionized water to remove the Li and chloride ions thoroughly, followed by drying under vacuum at about 80° C. for about 24 h. The structure of [EMIm]FSI was determined by ¹H NMR and infrared spectroscopy.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. An ionic liquid electrolyte comprising lithium cations, sodium cations, organic cations, and fluorinated anions, wherein a concentration of the lithium cations is about 1.3 M or greater.

2. The ionic liquid electrolyte of claim 1, wherein the concentration of the lithium cations is about 1.5 M or greater, about 2 M or greater, about 2.5 M or greater, about 3 M or greater, about 3.5 M or greater, about 4 M or greater, about 4.5 M or greater, or about 5 M or greater.

3. The ionic liquid electrolyte of claim 1, wherein a concentration of the sodium cations is about 0.05 M or greater, about 0.07 M or greater, about 0.1 M or greater, about 0.13 M or greater, or about 0.16 M or greater.

4. The ionic liquid electrolyte of claim 3, wherein a ratio of the concentration of the lithium cations to the concentration of the sodium cations is about 12 or greater, about 15 or greater, about 17 or greater, about 20 or greater, about 23 or greater, about 25 or greater, about 27 or greater, or about 30 or greater.

5. The ionic liquid electrolyte of claim 1, wherein the organic cations include imidazolium cations.

6. The ionic liquid electrolyte of claim 5, wherein the imidazolium cations are 1,3-dialkylimidazolium cations.

7. The ionic liquid electrolyte of claim 6, wherein the 1,3-dialkylimidazolium cations are 1-ethyl-3-methylimidazolium cations.

8. The ionic liquid electrolyte of claim 1, wherein the fluorinated anions include first fluorinated anions and second fluorinated anions which are different from the first fluorinated anions.

9. The ionic liquid electrolyte of claim 8, wherein the first fluorinated anions are first sulfonamide anions, and the second fluorinated anions are second sulfonamide anions which are different from the first sulfonamide anions.

10. The ionic liquid electrolyte of claim 9, wherein the first sulfonamide anions are bis(fluorosulfonyl)imide anions, and the second sulfonamide anions bis(trifluoromethanesulfonyl)imide anions.

11. The ionic liquid electrolyte of claim 9, wherein a concentration of the first sulfonamide anions is greater than a concentration of the second sulfonamide anions.

12. The ionic liquid electrolyte of claim 1, wherein the ionic liquid electrolyte has a viscosity of up to about 200 mPa s at 22° C.

13. The ionic liquid electrolyte of claim 12, wherein the viscosity is about 180 mPa s or less, about 160 mPa s or less, about 140 mPa s or less, or about 130 mPa s or less.

14. The ionic liquid electrolyte of claim 1, wherein the ionic liquid electrolyte has an ionic conductivity of at least about 1.5 mS cm⁻¹ at 25° C.

15. The ionic liquid electrolyte of claim 14, wherein the ionic conductivity is about 1.7 mS cm⁻¹ or greater, about 2 mS cm⁻¹ or greater, about 2.3 mS cm⁻¹ or greater, or about 2.6 mS cm⁻¹ or greater.

16. An ionic liquid electrolyte comprising an ionic liquid, a lithium salt, and a sodium salt, wherein a molar ratio of lithium included in the lithium salt to sodium included in the sodium salt is at least about 12.

17. The ionic liquid electrolyte of claim 16, wherein the molar ratio of lithium included in the lithium salt to sodium included in the sodium salt is about 15 or greater, about 17 or greater, about 20 or greater, about 23 or greater, about 25 or greater, about 27 or greater, or about 30 or greater.

18. The ionic liquid electrolyte of claim 16, wherein the ionic liquid includes organic cations and fluorinated anions.

19. The ionic liquid electrolyte of claim 18, wherein the organic cations include imidazolium cations.

20. The ionic liquid electrolyte of claim 19, wherein the imidazolium cations are 1,3-dialkylimidazolium cations.

21. The ionic liquid electrolyte of claim 20, wherein the 1,3-dialkylimidazolium cations are 1-ethyl-3-methylimidazolium cations.

22. The ionic liquid electrolyte of claim 18, wherein the fluorinated anions are sulfonamide anions.

23. The ionic liquid electrolyte of claim 22, wherein the sulfonamide anions are bis(fluorosulfonyl)imide anions.

24. The ionic liquid electrolyte of claim 16, wherein the lithium salt includes lithium cations and fluorinated anions.

25. The ionic liquid electrolyte of claim 24, wherein the fluorinated anions included in the lithium salt are sulfonamide anions.

26. The ionic liquid electrolyte of claim 25, wherein the sulfonamide anions included in the lithium salt are bis(fluorosulfonyl)imide anions.

27. The ionic liquid electrolyte of claim 16, wherein the sodium salt includes sodium cations and fluorinated anions.

28. The ionic liquid electrolyte of claim 27, wherein the fluorinated anions included in the sodium salt are sulfonamide anions.

29. The ionic liquid electrolyte of claim 28, wherein the sulfonamide anions included in the sodium salt are bis(trifluoromethanesulfonyl)imide anions.

30. The ionic liquid electrolyte of claim 16, wherein the ionic liquid electrolyte has a viscosity of up to about 200 mPa s at 22° C.

31. The ionic liquid electrolyte of claim 30, wherein the viscosity is about 180 mPa s or less, about 160 mPa s or less, about 140 mPa s or less, or about 130 mPa s or less.

32. The ionic liquid electrolyte of claim 16, wherein the ionic liquid electrolyte has an ionic conductivity of at least about 1.5 mS cm⁻¹ at 25° C.

33. The ionic liquid electrolyte of claim 32, wherein the ionic conductivity is about 1.7 mS cm⁻¹ or greater, about 2 mS cm⁻¹ or greater, about 2.3 mS cm⁻¹ or greater, or about 2.6 mS cm⁻¹ or greater.

34. A battery comprising an anode, a cathode, and the electrolyte of claim 1 disposed between the anode and the cathode.
